(19) United States
(12) Patent Application Publication
(10) Pub. No.: US 2024/0087052 A1
(43) Pub. Date: Mar. 14, 2024

(54) COMMUNITY PROFILES

(71) Applicant: Meta Platforms, Inc., Menlo Park, CA (US)

(72) Inventors: Ryan Keenan Olson, Aspen, CO (US); Peter Michael Cottle, Boulder, CO (US); Alexandra Louise Krakaris, Lafayette, CA (US); Ryan Michael O'rourke, San Francisco, CA (US)

(21) Appl. No.: 17/940,538

(22) Filed: Sep. 8, 2022

(51) Int. Cl. G06Q 50/00; G06Q 10/10

(52) U.S. Cl. CPC G06Q 50/01; G06Q 10/101

(57) ABSTRACT

Techniques are described for a social networking system to provide community profiles that allow for multiple holders, editors, and/or managers. In some cases, the social networking system may be configured to distribute content associated with the community profiles based on metrics and relationships associated with accounts of the collaborators to the community profile as well as the community profile itself.

### BACKGROUND

Social networking systems provide users with functionality to share content with other users. Most conventional social networking systems provide sharing in a one-to-one or one-to-many relationship via a user's account or page. However, there are times when multiple users work together on a project or participate together in an event. In that case, multiple users may wish to post about the project or event. Current systems require each user to both register their own profile and to create their own individual post(s) about the project or event to share with their connections on a social networking system.

### BRIEF DESCRIPTION OF THE DRAWINGS

The detailed description is described with reference to the accompanying figures. In the figures, the left-most digit(s) of a reference number identifies the figure in which the reference number first appears. The use of the same reference numbers in different figures indicates similar or identical components or features.

FIG. 1 is a view of an example system usable to assist with sharing community content via a community profile, according to some implementations.

FIG. 2 is a view of another example system usable to assist with sharing community content via a community profile, according to some implementations.

FIG. 3 is a view of yet another example system usable to assist with sharing community content via a community profile, according to some implementations.

FIG. 4 is a view of an example system usable to assist with creating a communication channel via a community profile, according to some implementations.

FIG. 5 is a view of an example system usable to assist with creating a communication channel via a community profile, according to some implementations.

FIG. 6 is a view of an example home interface associated with a community profile, according to some implementations.

FIG. 7 is a view of an example interface for viewing community content associated with a community profile, according to some implementations.

FIG. 8 is a view of an example interface for creating community content associated with a community profile, according to some implementations.

FIG. 9 is an example interface illustrating a community chat feed, according to some implementations.

FIG. 10 is an example interface for opting into a community chat, according to some implementations.

FIG. 11 is an example interface for initiating a threaded conversation, according to some implementations.

FIG. 12 is an example interface illustrating a hierarchical nature of a threaded conversation within a community chat, according to some implementations.

FIG. 13 is an example interface illustrating a communication channel, according to some implementations.

FIG. 14 is an example interface for managing communication channels, according to some implementations.

FIG. 15 is an example interface for managing communication channels, according to some implementations.

FIG. 16 is an example interface for managing global chat permissions, according to some implementations.

FIG. 17 is an example interface for managing individual chat permissions, according to some implementations.

FIG. 18 is a flow diagram illustrating an example process for initiating creation of a community profile via the social networking system, according to some implementations.

FIG. 19 is a flow diagram illustrating an example process for creating community content for a community profile via the social networking system, according to some implementations.

FIG. 20 is a flow diagram illustrating an example process associated with generating feedback to content associated with a community profile, according to some implementations.

FIG. 21 is an example system and device that is usable to implement the techniques described herein, according to some implementations.

### DETAILED DESCRIPTION

Social networking systems and websites are often used to promote events, projects, and the like via the sharing of content related to the events and/or projects. However, many of the conventional systems are directed to assisting social network users in promoting and providing information or content related to events or products in the form of text, images, video, and the like on an individual basis. For example, in conventional systems, content is posted, managed, shared, and/or stored with respect to a single user and a single user's account. Similarly, comments and other feedback associated with a content item or individual post is associated with and/or directed to the attention of the individual account holder. For example, content may be shared directly to multiple users following a user's account. In some cases, when the content is presented, if the content fails to meet or exceed a content or quality threshold and/or a relevancy threshold associated with a viewer, the viewer may unfollow the user's account, which decreases the social status of the user. This leads to pressure on the user to always produce high-quality content, which may be stifling for creativity in the conventional systems. Alternatively, the social networking system, discussed herein, may be configured to allow users to create, share, and interact with content as a group or set of users via the community profiles. Rather than sharing content associated with the community to individuals following a specific collaborators which presents a risk of being unfollowed or suffering harm to the collaborators personal profile or account, the collaborator may share the content via the specific community profile or groups that represent events, interests, or projects. This community content is then engaged with by other users following that event, interest, or project, which reduces risk of lost followers for the collaborator with respect to publishing content that is not relevant for particular followers while also leading to better engagement rates and a better overall experience on the platform.

The social networking system, discussed herein, is configured to allow users to create, share, and interact with content as a group or set of users via community profiles. For example, a group or set of users may create, interact with, or otherwise manage a community profile dedicated to a particular topic or interest group. In some cases, the community profile may have multiple account holders or users that are associated therewith. In some cases, a single user or original user may create a community profile and invite co-collaborators to post, share, and/or otherwise edit content associated with the community profile. With respect to the content created and shared via the community profile, the content may be stored in association with the community profile and distributed to a union of the set of users that are associated with individual users of the multiple co-collaborators. For instance, a post associated with the community profile may be distributed to each of the users “following” or otherwise associated with each of the individual co-collaborators as well as the users “following” or associated with the community profile.

As an illustrative example, a community profile may have a first, a second, and a third co-collaborator (or more). When content is posted to the community profile, the content may be distributed to or a notification related with the content may be provided to a set of users that includes the followers of the first co-collaborator, the followers of the second co-collaborator, the followers of the third co-collaborator, and the direct followers of the community profile. The set of users may be filtered to remove any duplicate users (e.g., a user associated with two or more of the first co-collaborator, the second co-collaborator, the third co-collaborator or the community profile). In this manner, the content does not need to be separately posted to each of the individual accounts of the first co-collaborator, the second co-collaborator, and the third co-collaborator, thereby reducing the overhead, total content and storage requirements, computer resource consumption, and network resource consumption associated with posting the community content.

In some examples, one or more administrators of the community profile may have a per-post or per-content approval rights with respect to the community profile. For example, each user or collaborator that creates content or posts for the community profile may cause the system to send a notification or alert to open or more administrators. The administrators may have the rights to review, approve, and/or deny publication of any content or post to the community profile before the system makes the content or post publicly available or viewable via the community profile. In some cases, the administrators may have an administrator user interface that displays the content and/or posts with interactive options to approve or disapprove each individual post. In some cases, the administrator user interface may include short exerts or portions (such as small clips) of the content or post that may be quickly consumed by the administrator. In some cases, the administrators may be able to select the content or post to view the full content.

In some examples, one or more of the co-collaborators, such as the original collaborator may also assign roles or flare (e.g., labels and/or classes) to the other co-collaborators. For example, the original collaborator may be an administrator that may assign other collaborators as administrators. Additionally, other roles or flare may be assigned to individual collaborators of the community profile. For example, a collaborator may be assigned an “OG” flare or label that may be displayed together with the user identifiers (e.g., profile pictures, name, and the like) to indicate to other users viewing the community profile that the collaborator is part of the original group or founding members of the community profile. In some cases, the flair may be created by the collaborators, such as by administrators, and subsequently assigned. In some instances, the flair may be system wide and have a defined meaning within the social media network.

Additionally, it should be understood that multiple levels of administrators may be associated with a community profile, such that different administrators may perform different roles. For instance, approval of content or post on per-post basis, approval of collaborators for unrestricted posting, approving new collaborators, assigning administrative roles, create channels, post to channels, and the like.

Similarly, the users receiving the distribution and/or notification of the content only receive the content and/or the notification a single time. For example, in conventional systems if a user was associated with both the accounts of the first co-collaborator and the second co-collaborator, the user would have received the content twice (once when the first co-collaborator posted the content and once when the second co-collaborator posted the content). In the social networking system discussed herein, the user only receives the content and/or notification once. In this manner, again, the total amount of content, system resource consumption, and network resource computation is reduced by reducing duplication of content and duplication of notifications.

In some examples, the community profile may be public and available to the users associated with the individual collaborators' accounts, as discussed above. In some alternative examples, the community profile may be private (e.g., only open to the co-collaborators). In the private accounts, the co-collaborators are able to share and collaborate on content with each other, without sharing to other users. In this manner, the community profile provides the co-collaborators with the ability to work jointly on content as a private group of more than two users via the social networking system.

In some examples, the community profile may also include one or more communication channels or “community chats” for collaborators, members, or even users viewing and consuming the community profile content. For example, a user may form or create a communication channel associated with the community profile. For instance, the communication channel may be for a set group of users, a specific topic, in reference to a specific post or content item a combination thereof, and the like. In some cases, the communication channel may be accessible via a user accessible option associated with the community profile and/or specific posts or content. Each of the communication channels may also be divided into sub-channels and/or threads. For example, a top level channel may be formed, and other collaborators or user of the social networking system may create sub-channels to discuss more specific topics under the original communication channel Each of the channels and/or sub-channels may be assigned an identifier that may be displayed while a user is consuming or viewing the respective channel and/or sub-channel. In some examples, when a user is viewing a comment that includes or initiated (e.g., the original comment that resulted in a sub-channel or thread) the system may display the sub-channel identifier, a number of comments on the sub-channel, and the like adjacent to the initiating comment. In various examples, when a user selects the sub-channel identifier, the user may be transition to the sub-channel and, thereby, consume the comments and/or content associated therewith.

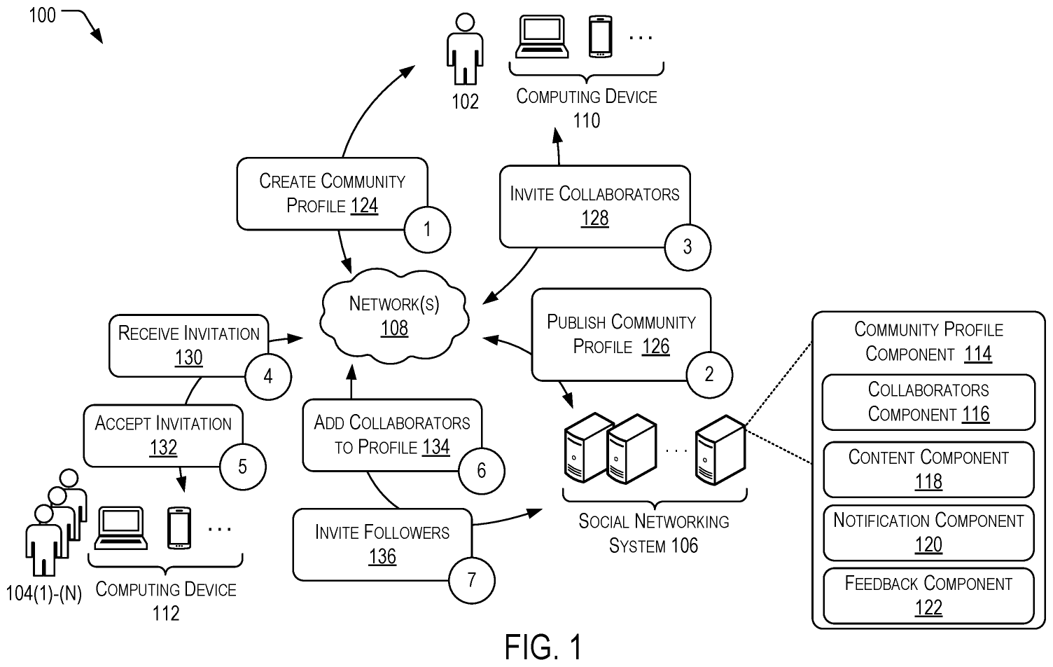

In some examples, when a user desires to add a comment to the community profile, the system may allow the user to enter the comment as an entry on an existing channel and/or sub-channel, create a new channel, and/or create a new sub-channel for the comment. In some specific example, the community chat interface, in addition to a reply or post option, may include a user selectable option to create a sub-channel or thread to allow the user to easily branch the channel In this manner, the social networking system allows for a chat interface that includes branching or threaded channels to assist with organization of the community chat. FIG. 1 is a view of an example system 100 usable to assist with sharing collective or collaborative content via a community profile, according to some implementations. In some examples, the system 100 may include a user 102 who may be an original account creator, as well as other users 104(1)-104(N) (collectively “users 104”), being invited as co-collaborator(s) on the community profile created by the user 102. The user 102 and users 104 may interact with a social networking system 106 via a network 108 using computing devices, generally indicated by 110 and 112, respectively. In some cases, the user 102 may be more than one host user but is referred to herein as a single user for clarity.

In the illustrated example, the social networking system 106 may include a community profile component 114. The community profile component 114 may include a number of sub-components or modules, such as collaborators component 116, content component 118, notification component 120, and/or feedback component 122. The collaborators component 116 may provide the user 102 with functionality to invite or add collaborators (e.g., the users 104) to the community profile. This functionality to invite or add the users 104 may include functionality to designate one or more of the users 104 as administrators of the community profile having authority to block, remove and/or restrict users. The content component 118 may be configured to provide functionality to create, edit, and host content to the user 102 and/or the users 104 with respect to the community profile. The notification component 120 may be configured to send content, alerts and/or notifications to other users (not shown) in response to the user 102 or users 104 creating and/or posting content via the content component 118. In some cases, the notification component 120 may also be configured to determine a set or subset of users (e.g., one or more followers (not shown) of the user 102 or users 104) to receive content, alerts and/or notifications. The feedback component 122 may be configured to determine one or more of the user 102 and users 104 to notify, provide to, and/or present feedback, comments, and the like related to the collective or community content.

With respect to FIG. 1, the user 102 may be inviting the users 104 to act as collaborators or joint account holders for a community profile. For instance, in the illustrated example, the user 102 may, at operation 124 (indicated by the numeral “1”), create a new, community profile such as in addition to an existing account. For instance, the user 102 may create an account in a manner of an individual user creating a personal account but select a collective or community profile option allowing multiple users to be account holders, contributors, and otherwise managers of the newly created community profile. For instance, the user 102 may specify identifying content (e.g., account name, address, and the like), background content (e.g., account story, purpose, goals, and the like), demographic or contact content (e.g., personal information of the user 102), initial content (e.g., original posts and the like), and the like.

In the illustrated example, at operation 126, (indicated by the numeral “2”), the social networking system 106 may create and/or publish the community profile. For example, if the community profile is a public account the social networking system 106 may publish a page or space associated with the community profile as well as any original content generated and/or recorded by the user 102. In an example where the community profile is a private account, the social networking system 106 may publish a page or space associated with the community profile but restrict or otherwise not publish any original content generated and/or recorded by the user 102.

Next, at operation 128 (indicated by the numeral “3”), the user 102 may invite one or more of the users 104 to act as collaborators with respect to the community profile. In some cases, the user 102 may initiate the invitation via a direct or private message from the community profile to one or more of the users 104. For example, the user 102 may select the users 104 by typing or entering any of the user's names, selecting any of the users 104 from a list or other identifying content (e.g., tagged and/or @-mentioned content) and the like. In some examples at operation 128, the user 102 may further designate one or more of the users 104 as administrators of the community profile. In the illustrated example, operation 128 is separated from operation 124, but it should be understood that in some cases, the invitation of the users 104 as collaborators may be incorporated into the community profile creation process.

At operation 130 (indicated by the numeral “4”), the users 104 may receive the invitation from the user 102 that was sent or otherwise transmitted at operation 128. For example, the users 104 may receive a notification or alert as to the creation of the community profile and/or an invitation to the community profile with the option to accept. Thus, at operation 132 (indicated by the numeral “5”), the users 104 may accept the invitation to be added as collaborator(s) with respect to the community profile. In the case where the invitation sent by the user 102 at operation 128 includes a designation of administrator of the community profile, the users 104 may respectively accept the invitation to be added as a collaborator of the community profile while declining the invitation to administrate the community profile. In the case where the users 104 accept the invitation to administrate the community profile, the social networking system 106 (i.e., the collaborators component 116) may grant such administrative rights to the users 104 in response.

In this example, at operation 134 (indicated by the numeral “6”), the social networking system 106 (i.e., the collaborators component 116) may add the users 104 that accepted the invitation as collaborators to the community profile. Once added, the users 104 may be able to post content, edit content, and the like with regards to the community profile. The user 104 may also be listed as owners (e.g., joint owners) or collaborators with respect to the community profile and/or content associated therewith. The social networking system may also, at operation 136 (indicated by the numeral “7”), invite followers or a subset of followers associated with each individual user 104 to follow the community profile. For example, followers of the users 104 may receive a notification informing the followers that the user 104 has joined the community profile and asking the followers if they would also like to follow the community profile.

In the illustrated example, each of the computing devices 110 and 112 may include one or more processors and memory storing computer executable instructions to implement the functionality discussed herein attributable to the various computing devices. In some examples, the computing devices 110 and 112 may include desktop computers, laptop computers, tablet computers, mobile devices (e.g., smart phones or other cellular or mobile phones, mobile gaming devices, portable media devices, etc.), or other suitable computing devices. The computing devices 110 and 112 may execute one or more client applications, such as a web browser (e.g., Microsoft Windows Internet Explorer, Mozilla Firefox, Apple Safari, Google Chrome, Opera, etc.) or a native or special-purpose client application (e.g., social media applications, messaging applications, email applications, games, etc.), to access and view content over the network 108.

The network 108 may represent a network or collection of networks (such as the Internet, a corporate intranet, a virtual private network (VPN), a local area network (LAN), a wireless local area network (WLAN), a cellular network, a wide area network (WAN), a metropolitan area network (MAN), or a combination of two or more such networks) over which the computing devices 110 and 112 may access the social networking system 106 and/or communicate with one another.

The social networking system 106 may include one or more servers or other computing devices, any or all of which may include one or more processors and memory storing computer executable instructions to implement the functionality discussed herein attributable to the social networking system or digital platform. The social networking system 106 may enable the user 102 and users 104 (such as persons or organizations) to interact with the social networking system 106 and with each other via the computing devices 110 and 112. The social networking system 106 may, with input from a user, create and store in the social networking system 106 a user account associated with the user. The user account may include demographic information, communication-channel information, and information on personal interests of the user. The social networking system 106 may also, with input from a user, create and store a record of relationships of the user with other users of the social networking system 106, as well as provide services (e.g., posts, comments, photo-sharing, messaging, tagging, mentioning of other users or entities, games, etc.) to facilitate social interaction between or among the users.

In some examples, the social networking system 106 may provide privacy features to the users 102 and 104 while interacting with the social networking system 106. In particular examples, one or more objects (e.g., content or other types of objects) of the system 106 may be associated with one or more privacy settings. The one or more objects may be stored on or otherwise associated with any suitable computing system or application, such as, for example, the social networking system 106, a client system, a third-party system, a social networking application, a messaging application, a photo-sharing application, or any other suitable computing system or application. Although the examples discussed herein are in the context of an online social network, these privacy settings may be applied to any other suitable computing system. Privacy settings (or “access settings”) for an object or item of content may be stored in any suitable manner, such as, for example, in association with the object, in an index on an authorization server, in another suitable manner, or any suitable combination thereof. A privacy setting for an object may specify how the object (or particular information associated with the object) can be accessed, stored, or otherwise used (e.g., viewed, shared, modified, copied, executed, surfaced, or identified) within the online social network. When privacy settings for an object allow a particular user or other entity to access that object, the object may be described as being “visible” with respect to that user or other entity. As an example, and not by way of limitation, a user of the online social network may specify privacy settings for a user-profile page that identify a set of users that may access work-experience information on the user-profile page, thus excluding other users from accessing that information.

In particular examples, privacy settings for an object may specify a “blocked list” and/or a “restricted list” of users or other entities that should not be allowed to access certain information associated with the object. In particular examples, the blocked list may include third-party entities. The blocked list or restricted list may specify one or more users or entities for which an object is not visible. As an example, and not by way of limitation, a user may specify a set of users who may not access photo albums associated with the user, thus excluding those users from accessing the photo albums (while also possibly allowing certain users not within the specified set of users to access the photo albums). In particular examples, privacy settings may be associated with particular social-graph elements. Privacy settings of a social-graph element, such as a node or an edge, may specify how the social-graph element, information associated with the social-graph element, or objects associated with the social-graph element can be accessed using the online social network. As an example, and not by way of limitation, a particular concept node corresponding to a particular photo may have a privacy setting specifying that the photo may be accessed only by users tagged in the photo and friends of the users tagged in the photo. In particular examples, privacy settings may allow users to opt in to or opt out of having their content, information, or actions stored/logged by the social-networking system or shared with other systems (e.g., a third-party system). Although this disclosure describes using particular privacy settings in a particular manner, this disclosure contemplates using any suitable privacy settings in any suitable manner.

In particular examples, privacy settings may be based on one or more nodes or edges of a social graph. A privacy setting may be specified for one or more edges or edge-types of the social graph, or with respect to one or more nodes or node-types of the social graph. The privacy settings applied to a particular edge connecting two nodes may control whether the relationship between the two entities corresponding to the nodes is visible to other users of the online social network. Similarly, the privacy settings applied to a particular node may control whether the user or concept corresponding to the node is visible to other users of the online social network. As an example, and not by way of limitation, a user, such as a user 102 and 104, may share an object to the social networking system 106. The object may be associated with a concept node connected to a user node of the user 102 and/or 104 by an edge. The user 102 and/or 104 may specify privacy settings that apply to a particular edge connecting to the concept node of the object or may specify privacy settings that apply to all edges connecting to the concept node. In some examples, the user 102 and/or 104 may share a set of objects of a particular object-type (e.g., a set of images). The user 102 and/or 104 may specify privacy settings with respect to all objects associated with the user 102 and/or 104 of that particular object-type as having a particular privacy setting (e.g., specifying that all images posted by the user 102 and/or 104 are visible only to friends of the user and/or users tagged in the images).

In particular examples, the social networking system 106 may present a “privacy wizard” (e.g., within a webpage, a module, one or more dialog boxes, or any other suitable interface) to the user 102 and/or 104 to assist the user in specifying one or more privacy settings. The privacy wizard may display instructions, suitable privacy-related information, current privacy settings, one or more input fields for accepting one or more inputs from the first user specifying a change or confirmation of privacy settings, or any suitable combination thereof. In particular examples, the social networking system 106 may offer a “dashboard” functionality to the user 102 and/or 104 that may display, to the user 102 and/or 104, current privacy settings of the user 102 and/or 104. The dashboard functionality may be displayed to the user 102 and/or 104 at any appropriate time (e.g., following an input from the user 102 and/or 104 summoning the dashboard functionality, following the occurrence of a particular event or trigger action). The dashboard functionality may allow the user 102 and/or 104 to modify one or more of the user's current privacy settings at any time, in any suitable manner (e.g., redirecting the user 102 and/or 104 to the privacy wizard).

Privacy settings associated with an object may specify any suitable granularity of permitted access or denial of access. As an example and not by way of limitation, access or denial of access may be specified for particular users (e.g., only me, my roommates, my boss), users within a particular degree-of-separation (e.g., friends, friends-of-friends), user groups (e.g., the gaming club, my family), user networks (e.g., employees of particular employers, students or alumni of particular university), all users (“public”), no users (“private”), users of third-party systems, particular applications (e.g., third-party applications, external websites), other suitable entities, or any suitable combination thereof. Although this disclosure describes particular granularities of permitted access or denial of access, this disclosure contemplates any suitable granularities of permitted access or denial of access.

In particular examples, one or more servers of the social networking system 106 may be authorization/privacy servers for enforcing privacy settings. In response to a request from the user 102 and/or 104 (or other entity) for a particular object stored in a data store, the social networking system 106 may send a request to the data store for the object. The request may identify the user 102 and/or 104 associated with the request and the object may be sent only to the user 102 and/or 104 (or a client system of the user) if the authorization server determines that the user 102 is authorized to access the object based on the privacy settings associated with the object. If the requesting user is not authorized to access the object, the authorization server may prevent the requested object from being retrieved from the data store or may prevent the requested object from being sent to the user. In the search-query context, an object may be provided as a search result only if the querying user is authorized to access the object, e.g., if the privacy settings for the object allow it to be surfaced to, discovered by, or otherwise visible to the querying user. In particular examples, an object may represent content that is visible to a user through a newsfeed of the user. As an example, and not by way of limitation, one or more objects may be visible to a user's “Trending” page. In particular examples, an object may correspond to a particular user. The object may be content associated with the particular user or may be the particular user's account or information stored on the social networking system 106, or other computing systems. As an example, and not by way of limitation, the user 102 and/or 104 may view one or more other users 102 and/or 104 of an online social network through a “People You May Know” function of the online social network, or by viewing a list of friends of the user 102. As an example, and not by way of limitation, the user 102 and/or 104 may specify that they do not wish to see objects associated with a particular other user (e.g., the user 102 and/or 104) in their newsfeed or friends list. If the privacy settings for the object do not allow it to be surfaced to, discovered by, or visible to the user 102 and/or 104, the object may be excluded from the search results. Although this disclosure describes enforcing privacy settings in a particular manner, this disclosure contemplates enforcing privacy settings in any suitable manner.

In particular examples, different objects of the same type associated with a user may have different privacy settings. Different types of objects associated with a user may also have different types of privacy settings. As an example, and not by way of limitation, the user 102 and/or 104 may specify that the user's status updates are public, but any images shared by the user are visible only to the user's friends on the online social network. In some examples, the user 102 and/or 104 may specify different privacy settings for different types of entities, such as individual users, friends-of-friends, followers, user groups, or corporate entities. In some examples, the user 102 and/or 104 may specify a group of users that may view videos posted by the user 102 and/or 104, while keeping the videos from being visible to the user's employer. In particular examples, different privacy settings may be provided for different user groups or user demographics. As an example, and not by way of limitation, the user 102 and/or 104 may specify that other users who attend the same university as the user 102 and/or 104 may view the user's pictures, but that other users who are family members of the user 102 and/or 104 may not view those same pictures.

In particular examples, the social networking system 106 may provide one or more default privacy settings for each object of a particular object-type. A privacy setting for an object that is set to a default may be changed by a user associated with that object. As an example, and not by way of limitation, all images posted by the user 102 and/or 104 may have a default privacy setting of being visible only to friends of the first user and, for a particular image, the user 102 and/or 104 may change the privacy setting for the image to be visible to friends and friends-of-friends.

In particular examples, privacy settings may allow the user 102 and/or 104 to specify (e.g., by opting out, by not opting in) whether the social networking system 106 may receive, collect, log, or store particular objects or information associated with the user 102 and/or 104 for any purpose. In particular examples, privacy settings may allow the user 102 and/or 104 to specify whether particular applications or processes may access, store, or use particular objects or information associated with the user. The privacy settings may allow the user 102 and/or 104 to opt in or opt out of having objects or information accessed, stored, or used by specific applications or processes. The social networking system 106 may access such information in order to provide a particular function or service to the user 102 and/or 104, without the social networking system 106 having access to that information for any other purposes. Before accessing, storing, or using such objects or information, the social networking system 106 may prompt the user 102 and/or 104 to provide privacy settings specifying which applications or processes, if any, may access, store, or use the object or information prior to allowing any such action. As an example, and not by way of limitation, the user 102 and/or 104 may transmit a message to the user 102 and/or 104 via an application related to the online social network (e.g., a messaging app), and may specify privacy settings that such messages should not be stored by the social networking system 106.

In particular examples, the user 102 and/or 104 may specify whether particular types of objects or information associated with the user 102 and/or 104 may be accessed, stored, or used by the social networking system 106. As an example, and not by way of limitation, the user 102 and/or 104 may specify that images sent by the user 102 and/or 104 through the social networking system 106 may not be stored by the social networking system 106. In some examples, the user 102 and/or 104 may specify that messages sent from the user 102 and/or 104 to another user may not be stored by the social networking system 106. In some cases, the user 102 and/or 104 may specify that all objects sent via a particular application may be saved by the social networking system 106.

In particular examples, privacy settings may allow the user 102 and/or 104 to specify whether particular objects or information associated with the user 102 and/or 104 may be accessed from particular client systems or third-party systems. The privacy settings may allow the user 102 and/or 104 to opt in or opt out of having objects or information accessed from a particular device (e.g., the phone book on a user's smart phone), from a particular application (e.g., a messaging app), or from a particular system (e.g., an email server). The social networking system 106 may provide default privacy settings with respect to each device, system, or application, and/or the user 102 and/or 104 may be prompted to specify a particular privacy setting for each context. As an example, and not by way of limitation, the user 102 and/or 104 may utilize a location-services feature of the social networking system 106 to provide recommendations for restaurants or other places in proximity to the user 102 and/or 104. The default privacy settings of the user 102 and/or 104 may specify that the social networking system 106 may use location information provided from the computing device 110 and/or 112 of the user 102 and/or 104 to provide the location-based services, but that the social networking system 106 may not store the location information of the user 102 and/or 104 or provide it to any third-party systems. The user 102 and/or 104 may then update the privacy settings to allow location information to be used by a third-party image-sharing application in order to geo-tag photos.

In particular examples, privacy settings may allow a user to engage in the ephemeral sharing of objects on the online social network. Ephemeral sharing refers to the sharing of objects (e.g., posts, photos) or information for a finite period of time. Access or denial of access to the objects or information may be specified by time or date. As an example, and not by way of limitation, a user may specify that a particular image uploaded by the user is visible to the user's friends for the next week, after which time the image may no longer be accessible to other users. In some examples, a company may post content related to a product release ahead of the official launch and specify that the content may not be visible to other users until after the product launch.

In particular examples, for particular objects or information having privacy settings specifying that they are ephemeral, the social networking system 106 may be restricted in its access, storage, or use of the objects or information. The social networking system 106 may temporarily access, store, or use these particular objects or information in order to facilitate particular actions of a user associated with the objects or information, and may subsequently delete the objects or information, as specified by the respective privacy settings. As an example, and not by way of limitation, the user 102 may transmit a message to the user 104, and the social networking system 106 may temporarily store the message in a data store until the user 104 has viewed or downloaded the message, at which point the social networking system 106 may delete the message from the data store. In some examples, continuing with the prior example, the message may be stored for a specified period of time (e.g., 2 weeks), after which point the social networking system 106 may delete the message from the data store.

In particular examples, changes to privacy settings may take effect retroactively, affecting the visibility of objects and content shared prior to the change. As an example, and not by way of limitation, the user 102 may share a first image and specify that the first image is to be public to all other users. At a later time, the user 102 and/or 104 may specify that any images shared by the user should be made visible only to a first user group. The social networking system 106 may determine that this privacy setting also applies to the first image and make the first image visible only to the first user group. In particular examples, the change in privacy settings may take effect only going forward. Continuing the example above, if the user 102 and/or 104 changes privacy settings and then shares a second image, the second image may be visible only to the first user group, but the first image may remain visible to all users. In particular examples, in response to a user action to change a privacy setting, the social networking system 106 may further prompt the user to indicate whether the user wants to apply the changes to the privacy setting retroactively. In particular examples, a user change to privacy settings may be a one-off change specific to one object. In particular examples, a user's change to privacy may be a global change for all objects associated with the user.

In particular examples, the social networking system 106 may determine that user 102 and/or 104 may want to change one or more privacy settings in response to a trigger action associated with the user 102 and/or 104. The trigger action may be any suitable action on the online social network. As an example, and not by way of limitation, a trigger action may be a change in the relationship between a first and second user of the online social network (e.g., “un-friending” a user, changing the relationship status between the users, etc.). In particular examples, upon determining that a trigger action has occurred, the social networking system 106 may prompt the user 102 and/or 104 to change the privacy settings regarding the visibility of objects associated with the user 102 and/or 104. The prompt may redirect the user 102 and/or 104 to a workflow process for editing privacy settings with respect to one or more entities associated with the trigger action. The privacy settings associated with the user 102 and/or 104 may be changed only in response to an explicit input from the user 102 and/or 104 and may not be changed without the approval of the user 102 and/or 104. As an example, and not by way of limitation, the workflow process may include providing the user 102 with the current privacy settings with respect to the user 104 or to a group of users (e.g., un-tagging the user 102 or the user 104 from particular objects, changing the visibility of particular objects with respect to the user 104 or a group of users), and receiving an indication from the user 102 to change the privacy settings based on any of the methods described herein, or to keep the existing privacy settings.

In particular examples, a user may need to provide verification of a privacy setting before allowing the user to perform particular actions on the online social network, or to provide verification before changing a particular privacy setting. When performing particular actions or changing a particular privacy setting, a prompt may be presented to the user to remind the user of his or her current privacy settings and to ask the user to verify the privacy settings with respect to the particular action. Furthermore, a user may need to provide confirmation, double-confirmation, authentication, or other suitable types of verification before proceeding with the particular action, and the action may not be complete until such verification is provided. As an example, and not by way of limitation, a user's default privacy settings may indicate that a person's relationship status is visible to all users (i.e., “public”). However, if the user changes his or her relationship status, the social networking system 106 may determine that such action may be sensitive and may prompt the user to confirm that his or her relationship status should remain public before proceeding. In some examples, a user's privacy settings may specify that the user's posts are visible only to friends of the user. However, if the user changes the privacy setting for his or her posts to being public, the social networking system 106 may prompt the user with a reminder of the user's current privacy settings of posts being visible only to friends, and a warning that this change will make all of the user's past posts visible to the public. The user may then be required to provide a second verification, input authentication credentials, or provide other types of verification before proceeding with the change in privacy settings. In particular examples, a user may need to provide verification of a privacy setting on a periodic basis. A prompt or reminder may be periodically sent to the user based either on time elapsed or a number of user actions. As an example, and not by way of limitation, the social networking system 106 may send a reminder to the user to confirm his or her privacy settings every six months or after every ten photo posts. In particular examples, privacy settings may also allow users to control access to the objects or information on a per-request basis. As an example, and not by way of limitation, the social networking system 106 may notify the user whenever a third-party system attempts to access information associated with the user and require the user to provide verification that access should be allowed before proceeding.

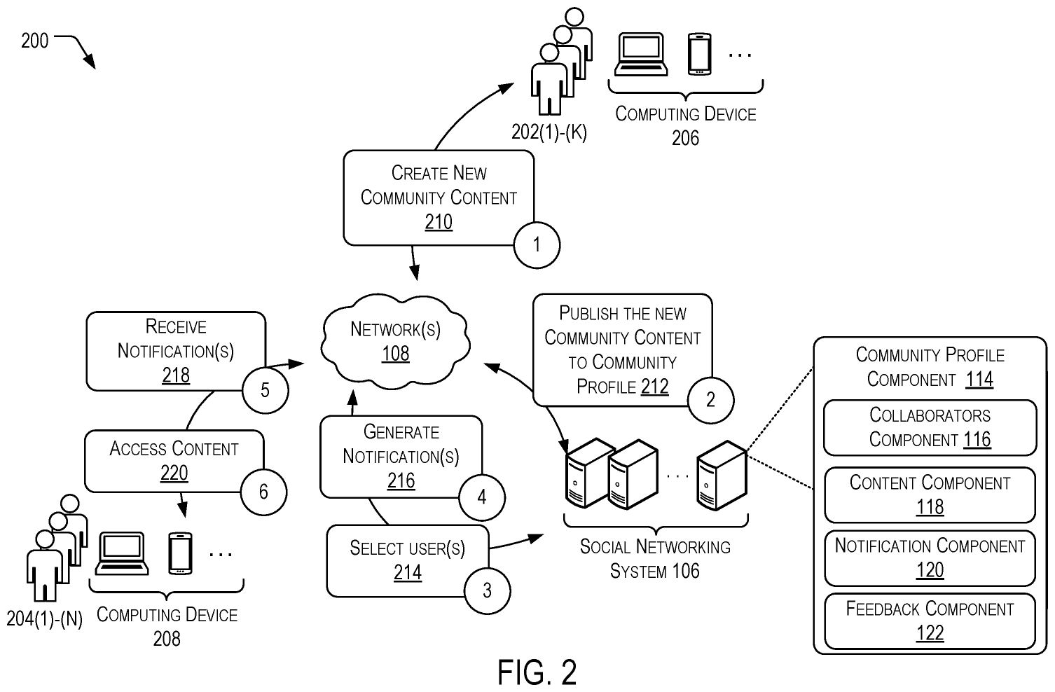

FIG. 2 is a view of another example system 200 usable to assist with sharing community content via a community profile, according to some implementations. In some examples, the system 200 may include a set of collaborators 202(1)-(K) (collectively “users 202”) as well as other users 204(1)-204(N) (collectively “users 204”) consuming content associated with the community profile and users 222(1)-222(J) (collectively “users 222”). In some cases, the users 202 are a set of users authorized to create, add, edit, remove, and otherwise modify content associated with the community profile, such as the user 102 and users 104 of FIG. 1. In some other cases, the users 202 (or a subset thereof) are authorized to block, remove, and/or restrict users or otherwise edit community settings associated with the community profile. As discussed above, the users 202 and 204 may interact with the social networking system 106 via the network 108 using computing devices, generally indicated by 206 and 208, respectively.

As discussed above with respect to FIG. 1, the social networking system 106 may include the community profile component 114. The community profile component 114 may include a number of sub-components or modules, such as the collaborators component 116, the content component 118, the notification component 120, and/or the feedback component 122.

With respect to FIG. 2, one or more of the users 202 may create content (e.g., community content) associated with, posted to, and/or hosted by the community profile. For instance, in the illustrated example, one or more of the users 202 may, at operation 210 (indicated by the numeral “1”), create a new content for the community profile. For instance, the users 202 may create the new community content via the content component 118 of the community profile component. In some cases, the new community content may be generated in a manner of an individual user creating new personal content but allow for multiple editors (e.g., the users 202) and/or attribution to multiple users (e.g., a subset of the users 202). For example, the users 202 may initiate creation of the new community content from a personal account and subsequently elect that the new community content be shared to the community profile. In some other cases, the new community content may be generated in a manner allowing for attribution to the community profile (i.e., all of the users 202). For example, the users 202 may initiate creation of the new community content from the community profile itself.

In some cases, the right and/or authority of the users 202 to create community content may be automatic. That is, any individual user of the users 202 may freely create and/or post community content to the community profile as described just above. In some other cases, the social networking system 106 (i.e., the content component 118) may be configured to provide functionality to create, edit, and host community content to only the user 102 and/or a subset of the users 104 having approval or authorization from the user 102 or an administrator of the community profile. In still some other cases, the social networking system 106 (i.e., the content component 118) may be configured to provide functionality to create, edit, and host community content to the users 202 on one or more of a “member-by member” or a “per-post” basis. In other words, the social networking system may be configured, in some cases, to restrict functionality of the users 202 to host community content to individual instances of community content having approval by an administrator or owner of the community profile.

In some cases, wherein the right and/or authority to create community content is determined on a member-by-member, a per-post, or a per-content item basis, the social networking system may further be configured to provide functionality to create, edit, and host community content according to a post type. For example, functionality to create, edit, and host one or more post types including but not limited to a story, a profile post, a message, an approval of another user, an image, and a text post may be restricted. In such cases, the social networking system may be configured either to restrict any individual users of the users 202 according to post type or, alternatively, to restrict only a subset of the users 202. For example, the social networking system may be configured to determine a relationship between individual users of the users 202, and based on such relationship, restrict functionality to create, edit, and host one or more post types.

Once the new community content is created, at operation 212 (indicated by the numeral “2”), the social networking system 106 may publish the new community content to the community profile. For example, the new community content may be published or made available to the other users 204 of the social networking system 106 at a specified or known location (such as a specific page associated with the community profile of the users 202).

At operation 214 (indicated by the numeral “3”), the social networking system 106 may select a subset of users of the social networking system 106 (such as the users 204 or a subset thereof) to send notification(s) or otherwise alert as to the newly published community content. In some cases, the subset of users 204 may be selected based on indicating that they are interested in content published by any of the users 202, as well as users that are following or have indicated an interest in content published by the community profile. In this manner, the subset of users 204 may include a union of the followers of the users 202 and the followers of the community profile, such that no users receive the notification related to the newly created community content more than once. In some examples, the subset of users 204 may be selected using other criterion in addition to or in lieu of belonging to the union of the collaborators' followers. In some cases, the other criterion may include followers of a subset of the users 202, a content topic or subject, areas of interest of the users 204, historical consumption of the users 204, other data known about the users 204, and the like.

At operation 216 (indicated by the numeral “4”), the social networking system 106 (i.e., the notification component 120) may send notification(s) or other alert related to the newly published community content to the subset of users 204 that were selected at operation 214. Further, at operation 218 (indicated by the numeral “5”), the subset of users 204 may receive the notification(s). In some cases, the notification(s) may be message(s), a posting of the content or the notification(s) to a particular location associated with the subset of users 204 (such as feeds associated with individual users), and the like. In some cases, the notification(s) may be summaries or highlight(s) of the content, such as one or more selected images or short videos associated with the content, short text-based descriptions, or other insights into the subject or topic of the content. In some cases, the content of the notification(s) may be selected by the users 202 when creating the community content. For example, the social networking system 106 (i.e., the content component 118) may be configured, at operation 210 described above, to allow the users 202 to select a featured image, portion of a video, or other data (e.g., a thumbnail/screenshot, or graphics interchange file (GIF)) to serve as a representation of the community content. In some cases, the notification(s) may include a link to access or otherwise consume the community content via the social networking system 106.

At operation 220 (indicated by the numeral “6”), one or more of the users 204 may access the community content via the notification or by accessing the specified location of the community content on the social networking system 106.

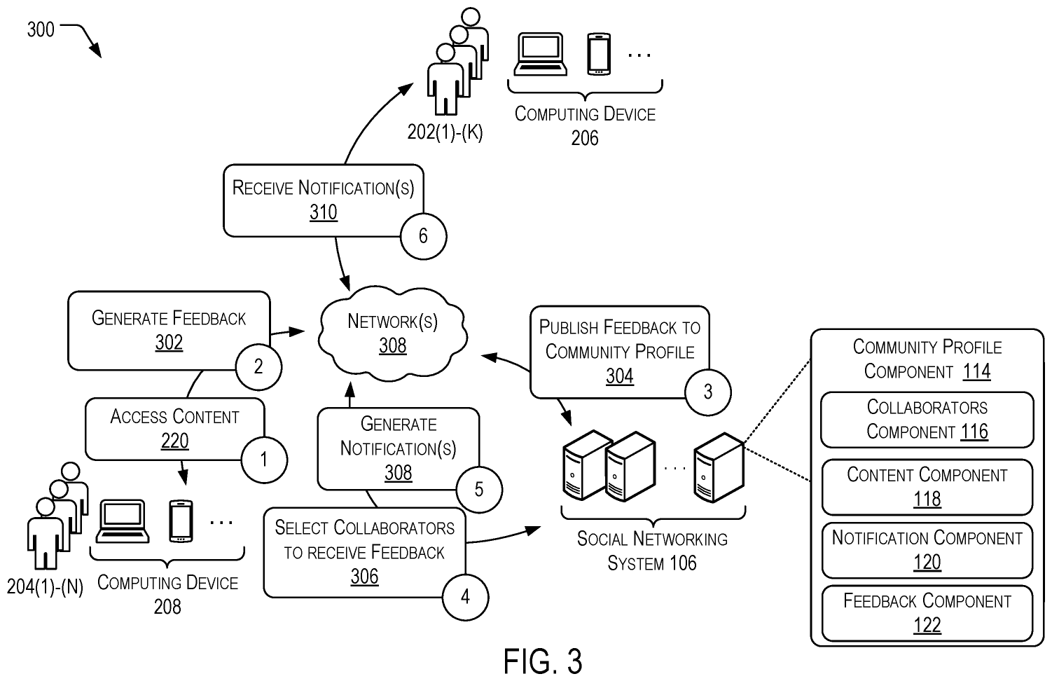

FIG. 3 is a view of yet another example system 300 usable to assist with sharing community content via a community profile, according to some implementations. In this example, the social networking system 106 may again include the community profile component 114, and the community profile component 114 may include the aforementioned sub-components: the collaborators component 116, the content component 118, the notification component 120, and/or the feedback component 122.

In the illustrated example, the users 204 may have already accessed the community content previously created with respect to the discussion of FIG. 2 and provided comments or other feedback to the collaborators 202 via the social networking system 106. In this example, one or more of the collaborators of the community profile (i.e., one or more of the users 202) may desire to provide replies or other context associated with the feedback. However, due to the number of users 202, the social networking system 106 may be configured to select a subset of the users 202 to respond, thereby reducing any duplication on the social networking system 106.

With respect to FIG. 3, at operation 220 (indicated by the numeral “1”), one or more of the users 204 may access the community content associated with the community profile of the users 202. The users 204 may then, at operation 302 (indicated by the numeral “2”), generate feedback or other engagement with the community content, such as commenting, liking, disliking, sharing, hiding, reposting or other interactions related to the community content posted to the community profile.

In response to receiving the feedback, the social networking system 106, at operation 304 (indicated by the numeral “3”), may publish or otherwise disseminate the feedback generated by the users 204 at operation 302 described above to the community profile. In some cases, the feedback may be published as a comment or other addition to the community content. In some other cases, the feedback may be added to one or more metrics associated with the community content (e.g., a number of likes or number of dislikes), and the like.

At operation 306 (indicated by the numeral “4”), the social networking system 106 may select one or more of the collaborators (i.e., one or more of the users 202) to receive a notification(s) related to the feedback, and at operation 308 (indicated by the numeral “5”), the social networking system 106 may generate and send the notification(s) to one or more of users 202. For example, the set of users receiving the notification(s) may be selected from the users 202 based on the content of the feedback, the type of feedback, the users 202 that contributed to the community content, and the like. For example, if the content of the feedback includes a tag/@-mention or other reference to an individual collaborator (i.e., one of the users 202), the social networking system 106 may a select and/or authorize the referenced collaborator(s) to receive and respond to the feedback.

The users 202 selected by the social networking system 106 may, at operation 310 (indicated by the numeral “6”), receive the notifications. In this manner, the users 202 may monitor feedback related to the community content and the reactions of the users 204. The feedback may help the users 202 gauge new community content to create, edits and/or updates to be made to the community content, and/or the like.

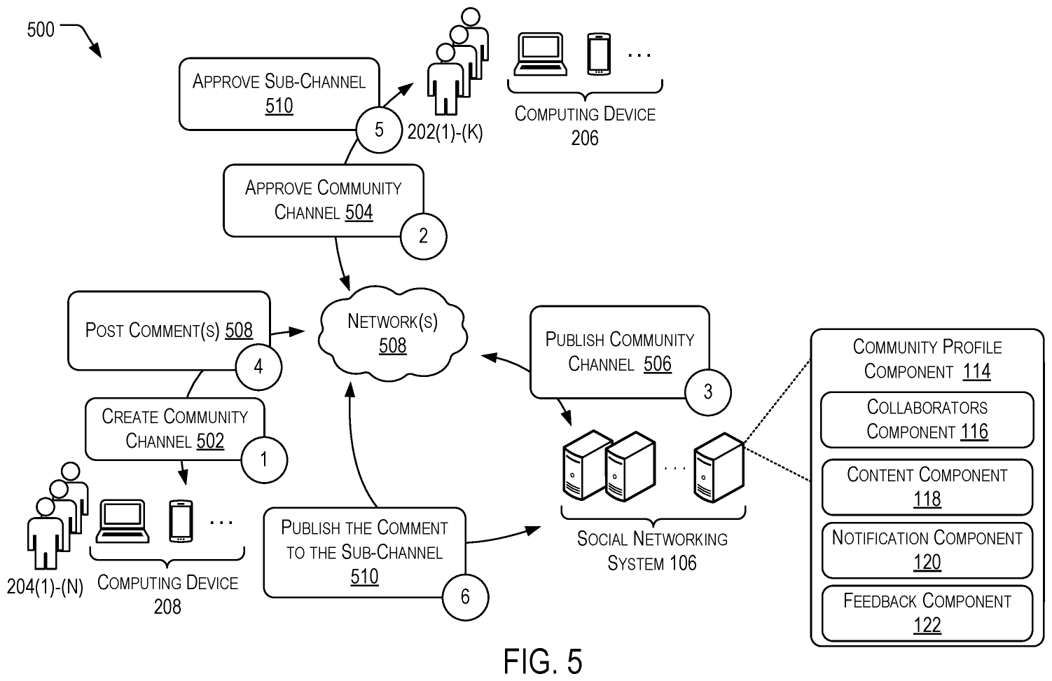

FIG. 5 is a view of another example system 500 usable to assist with creating and maintaining communication channels or “community chats” via a community profile, according to some implementations. In some examples, the system 500 may include a user s02 who may be an administrator, as well as other users 204(1)-204(N) (collectively “users 204”), being invited as co-collaborator(s) to join one or more communication channels on the community profile. The user 102 and users 204 may interact with a social networking system 106 via a network 108 using computing devices, generally indicated by 110 and 112, respectively. In some cases, the user 102 may be more than one host user but is referred to herein as a single user for clarity.

As discussed above with respect to FIG. 1, the social networking system 106 may include the community profile component 114. The community profile component 114 may include a number of sub-components or modules, such as the collaborators component 116, the content component 118, the notification component 120, and/or the feedback component 122.

With respect to FIG. 5, a first user 204(1) may, at operation 502 (indicated by the numeral “1”), create a new communication channel for the community profile. For instance, the first user 204(1) may create the new communication channel via the content component 118 of the community profile component.

Once the new communication channel is created, at operation 504 (indicated by the numeral “2”), the administrative user 202 may approve the community channel. For example, the administrative user 202 may have the option to approve (such as when approval is required on a per-post level), the community channel.

At operation 506 (indicated by the numeral “3”), the social networking system 106 may publish the community channel to the community profile. For example, the new communication channel may be published or made available to the other users 204 of the social networking system 106 at a specified or known location.

At operation 508 (indicated by the numeral “4”), a second user 204(2) may post a comment to the communication channel In this example, the second user 204(2) may also indicate that the comment should be included in a sub-channel of the communication channel.

At operation 510 (indicated by the numeral “5”), the administrative user 202 may approve the sub-channel. For example, the administrative user 202 may have the option to approve (such as when approval is required on a per-post level), the community channel.

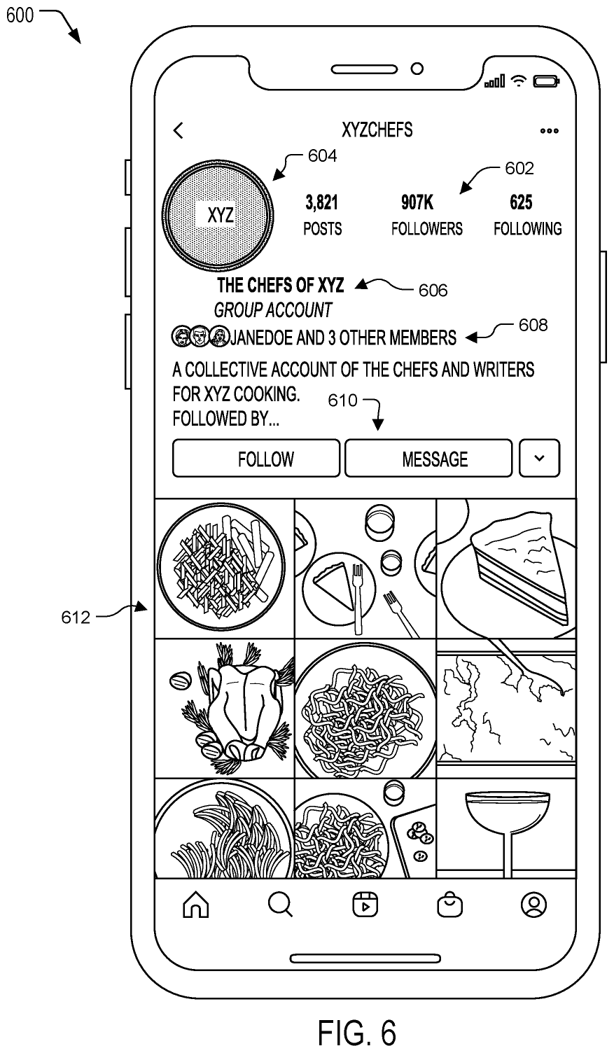

At operation 512 (indicated by the numeral “6”), the social networking system 106 may publish the community channel to the community profile. For example, the new sub-channel may be published or made available to the other users 204 of the social networking system 106 via a specific location and/or via an identifier within the original communication channel FIG. 6 is a view of an example interface 600 associated with a community profile according to some implementations. In the illustrated example, the interface 600 may include a metrics section 602 associated with the community profile, an icon section 604 associated with the community profile, a name or title section 406 associated with the community profile, a co-collaborators/contributors section 608 associated with the community profile, an interactive icon section 610 associated with the community profile, and a content section 612 associated with the community profile.

In the illustrated example, the metrics section 602 may include various metrics associated with the community profile and/or community content associated with the community profile. For instance, as shown, the metrics section 602 may include one or more metrics such as a number of posts, a number of followers, a number of users the community profile is following, and the like. The icon section 604 may include a graphic associated with the community profile, selected for instance, by the original collaborator (e.g., user 104 of FIG. 1) during operation 124 described above with reference to FIG. 1. The name or title section 606 may include the name of the community profile and/or a short description of the subject matter related to or the purpose of the community profile.

In the current example, the co-collaborators/contributors section 608 includes three icons associated, respectively, with three of the co-collaborators (i.e., three of the users 202) of the community profile. Further, the co-collaborators/contributors section 608 of the current example also includes a message indicating that Jane Doe (i.e., the user 104) is the original collaborator/owner of the community profile and that an additional three co-collaborators are associated with the community profile.

In some cases, the example interface 600 may be configured to display flair, such as labels, classes, or other visually distinguishing mark, for co-collaborators (i.e., the users 202) from the original collaborator/owner of the community profile. As an illustrative, but non-limiting example, text associated with the original collaborator/owner may be visually distinct, such as being presented in larger or bolder font, or the like. As another non-limiting example, one or more icons associated with co-collaborators may be visually distinct from an icon associated with the collaborator/owner. In some cases, a viewing user may be able to see a full list of the co-collaborators by selecting or otherwise interacting with the co-collaborators/contributors section 608.

It should also be understood that while three icons are shown in the co-collaborators/contributors section 608 of the illustrated example, the example interface 600 may be configured to display any number of icons as well as names or other identifiers of the contributors. It should also be understood that the number of contributors may vary such that the message indicating “and 3 other members” may display any appropriate number of additional contributors. Further, as discussed herein, the owner or managing users of the community profile are referred to as co-collaborators but it should be understood that the owner users may be referred to via other nomenclature, such as contributors, account holders, account users, and the like.

The interactive icon section 610 may include a number of selectable options for the viewing user, such as “follow,” or “message”. In other examples, the interactive icon section 610 may include other selectable or interactive options including “share profile URL” or the like. The content section 612 may include various community content items that may be viewed or consumed by user of the social networking system 106.

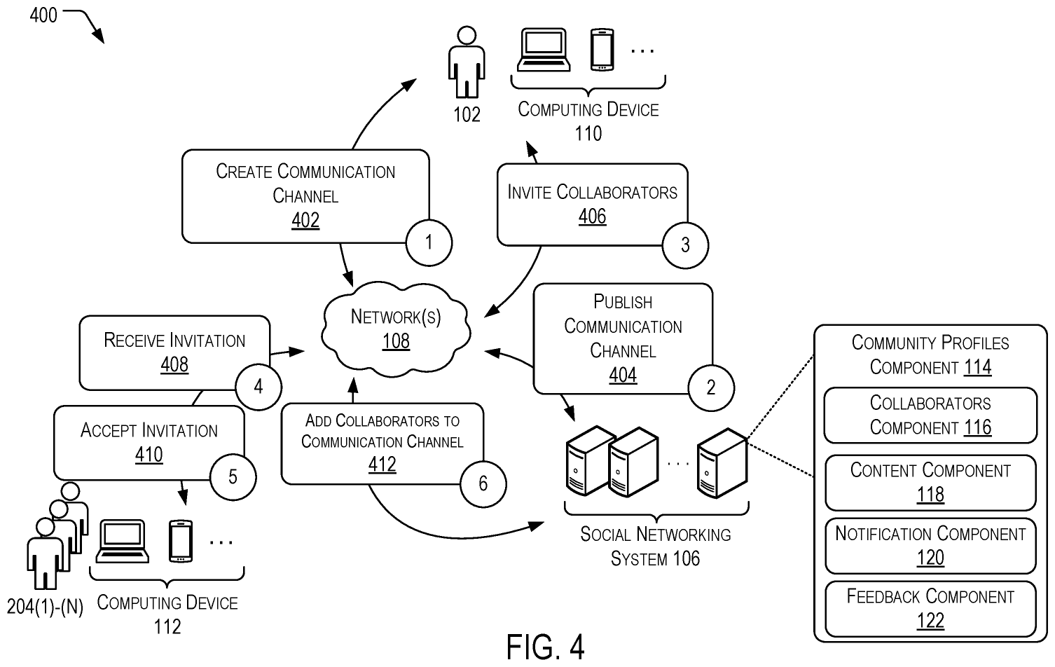

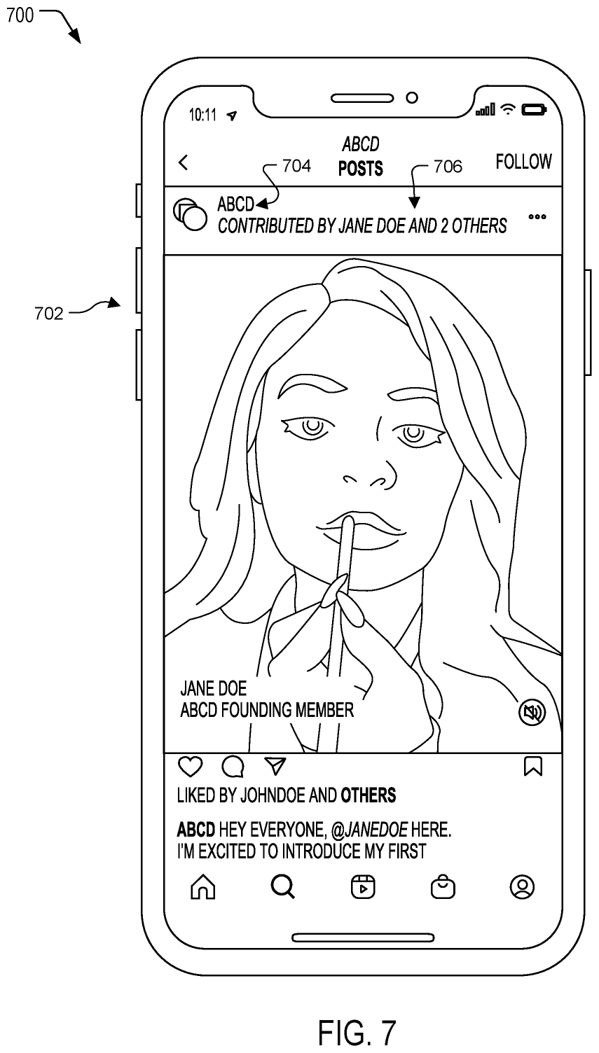

FIG. 7 is a view of an example interface 700 for viewing community content 702 associated with a community profile according to some implementations. In this example, the name or title 704 of the community profile may be displayed together with the contributing collaborator(s) (e.g., the one or more users 202 that generated the community content 702), generally indicated by indicator 706. In some cases, similar to the interface 400 of FIG. 4, if more than a predetermined number of collaborators contribute to the community content, the indicator 706 may be configured to display that there are additional collaborators contributing to the community content 702.

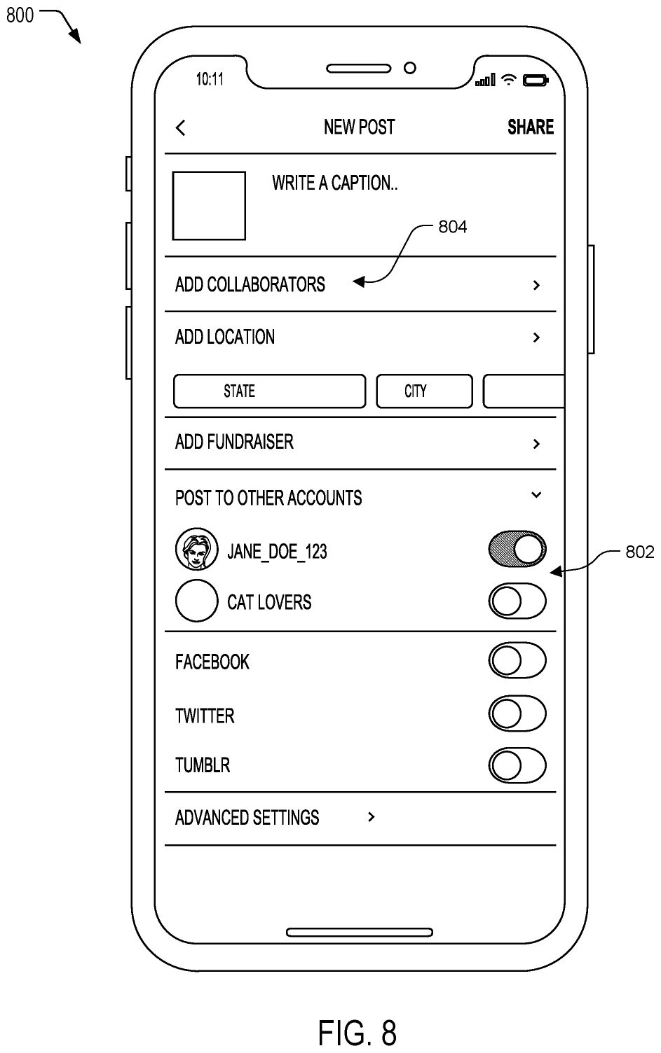

FIG. 8 is a view of an example interface 800 for creating community content, such as the community content 702 of FIG. 7, associated with a community profile according to some implementations. In this example, a collaborator may create a new community content (such as according to operation 210 described above with reference to FIG. 2) and select the account to which the new community content will be posted via the post selection section 802. For example, the collaborator may post the content to either their personal account (i.e., the “Jane Doe 123” account shown as selected in the illustrated example) or to another account they are contributing to or collaborating on (e.g., the “Cat Lovers” account shown as de-selected in the illustrated example). In some case, the interface 800 may include a section 804 to select other collaborators as contributing to the community content being created. In other example, the additional collaborators or contributors may be added later, such as part of a “tagging” process. Although the illustrated example shows the new community content being generated from the community profile, it should be understood that the new community content could also be generated from a collaborator's personal account (e.g., from the “Jane Doe 123”) account and then posted to the community profile.

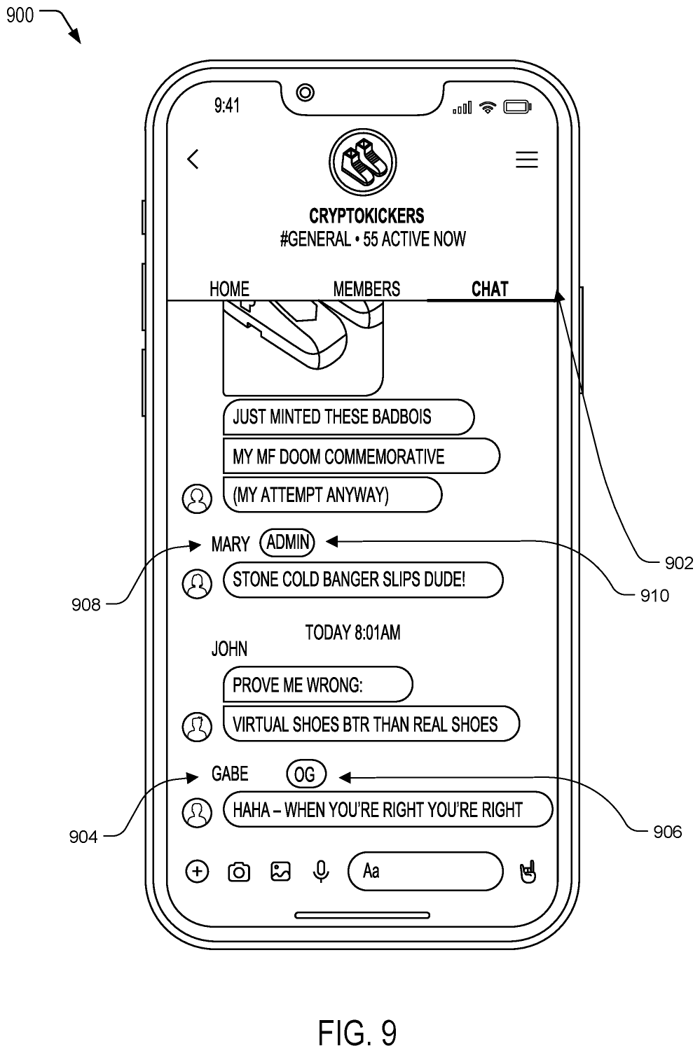

In some cases, the social networking system 106 may be configured to facilitate community chat functionality. That is, the social networking system 106 may be configured to allow the users 104 to engage in real-time and/or asynchronous dialog within a dedicated communication channel. For example, FIG. 9 illustrates an example interface 900 illustrating a community chat feed. For example, the community chat feed may be accessed from community homepage. In some cases, the community chat feed may be accessed by interacting with an interface object such as chat button 902. In the illustrated example, three interface objects are shown. However, the social networking system 106 may be configured to present any appropriate number of interface objects.

The current example interface 900 also illustrates an example of flair (e.g., a label or class) assigned to a user. For example, the user “gabe”, indicated by 904, has the assigned label “OG”, generally indicated by 906, and the user “mary”, indicated by 908, has the assigned label “ADMIN”, generally indicated by 910. In this manner, the consuming or viewing user may easily recognize or be made aware of the status of individual members or collaborators of the community profile while viewing content associated with the collaborator, such as when viewing a chat post associated with the user (e.g., users such as “gabe” and/or “mary”).

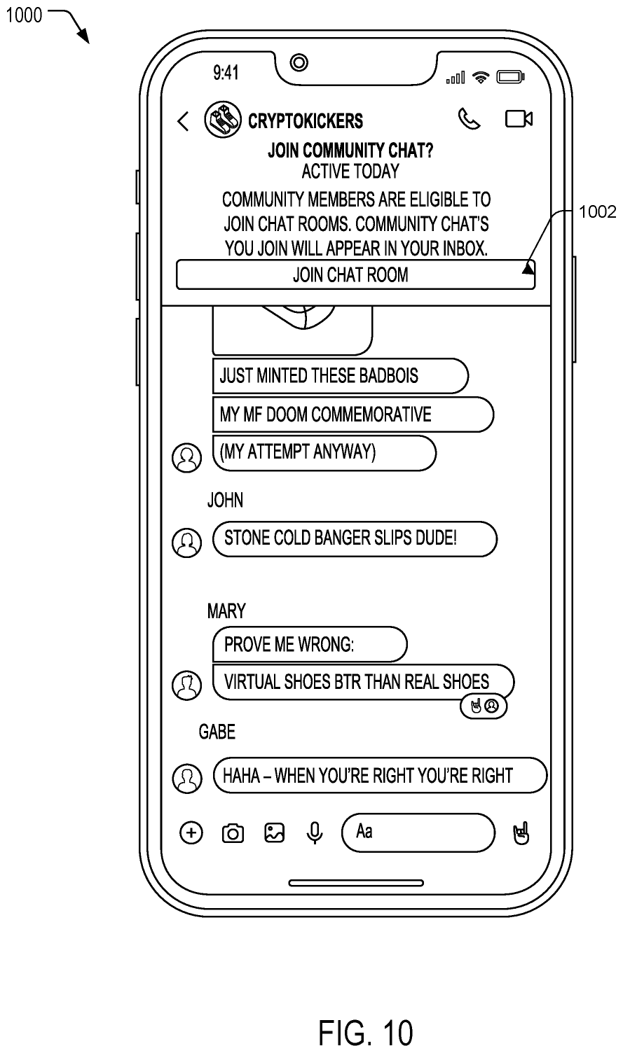

With brief reference to FIG. 10, illustrated therein is an example interface 1000 for opting into a community chat. For example, in some cases, the example interface 1000 may comprise a landing page with which the user is presented upon acceptance or otherwise joining the community. In some cases, the user may be presented with an interface object such as join chat button 1002 (which may be a floating action button, text link, icon button or the like), whereby the user may interact with example interface 1000 to opt-into or join a community chat. By providing an opt-in functionality for community chats, such as via example interface 1000, the social networking system 106 may be configured to allow user autonomy regarding the volume of miscellaneous communication.

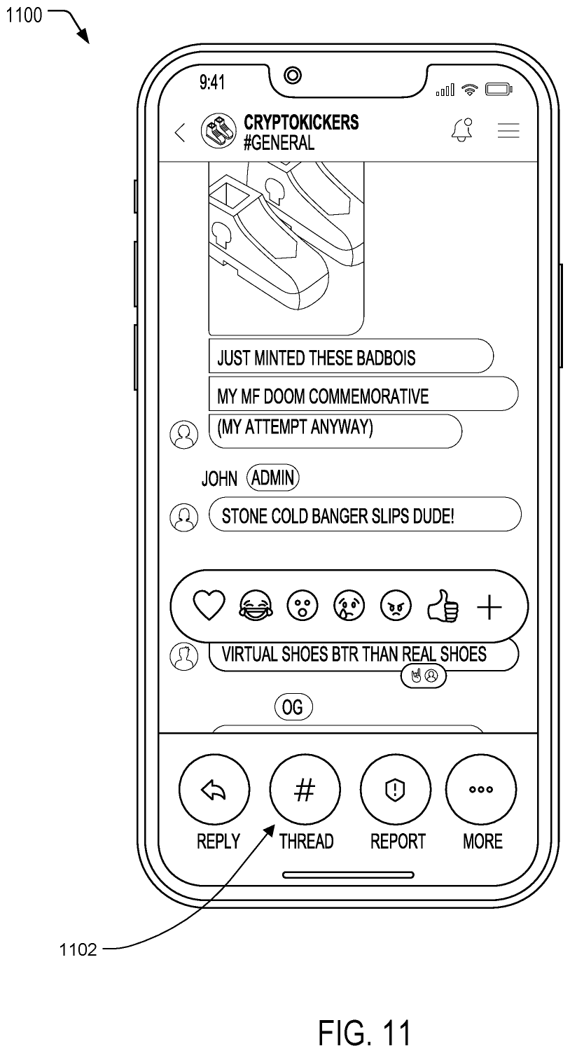

In some cases, the social networking system 106 may further be configured to provide threaded conversation functionality within the community chat. A threaded conversation (also referred to herein as a “thread”) may be a running commentary grouped or presented as a series of replies to a single message. Briefly turning to FIG. 11, illustrated is an example interface 1100 for initiating a threaded conversation within the community chat. In some cases, community chat interface, such as example interface 1100 may include one or more chat interface objects such as thread interface object 1102. For example, a user may interact with thread interface object 1102 in order to initiate or respond within a series of replies to a particular message, rather than replying to the general conversation being maintained within the community chat.

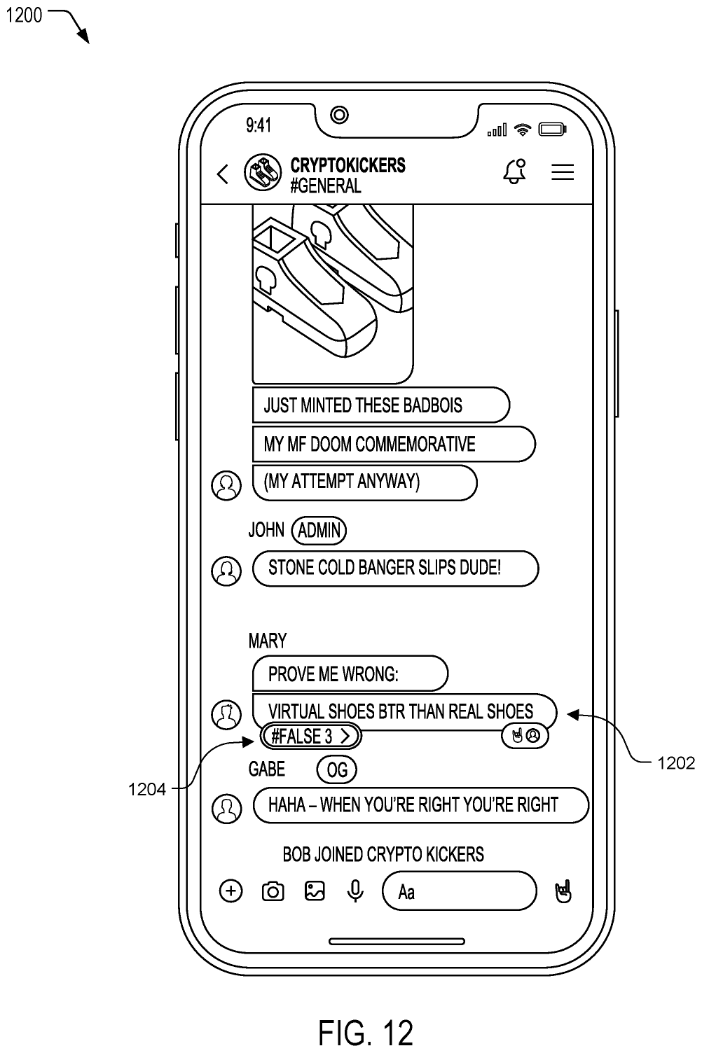

Turning to FIG. 12, illustrated therein is an example interface 1200 illustrating the hierarchical nature of a threaded conversation within a community chat. In the illustrated example, an originating message reads “virtual shoes btr than real shoes,” generally indicated by 1202. Shown nested under the originating message 1202 is an interface object, generally indicated by 1204, indicating a thread or sub-channel “#False 3” containing three (3) replies to the original message 1202. In some cases, by selecting the interface object 1204 the consuming or viewing user may be transitioned from the original thread or channel “#General” to the sub-thread or sub-channel “#False 3.”

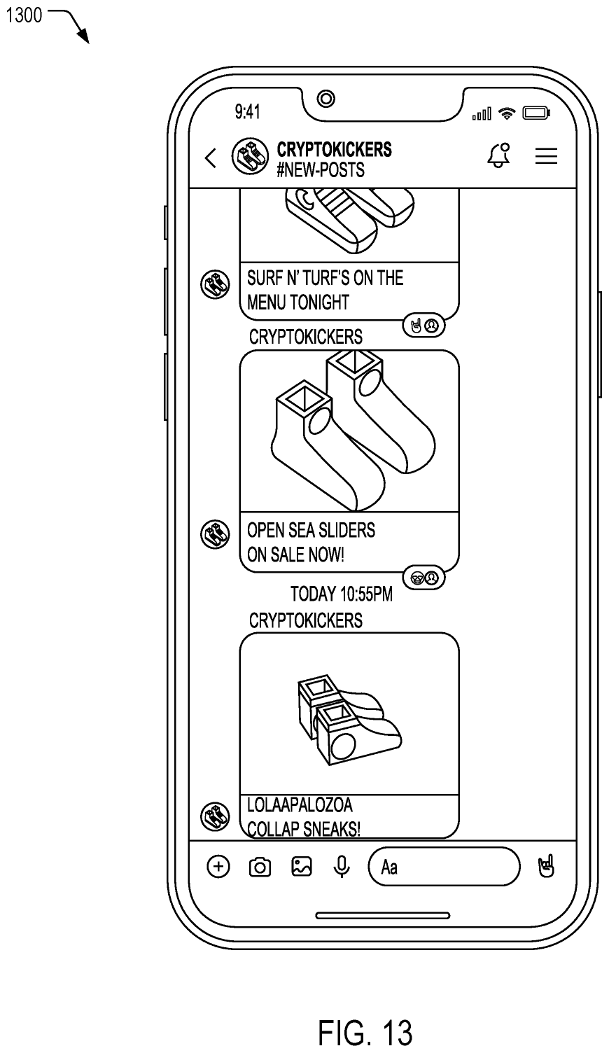

As discussed above, the social networking system 106 may further be configured to provide threads and/or sub-channel functionality for community chats. That is, in some cases, the social networking system 106 may be configured to provide functionality to generate and maintain labeled communication channels. For instance, as shown in the example interface 1300 of FIG. 13, a communication channel dedicated to “#new-posts” may be maintained. In this way, the social networking system 106 may facilitate robust communication amongst co-collaborators and allow viewing users to determine the current thread and/or sub-channel more easily.

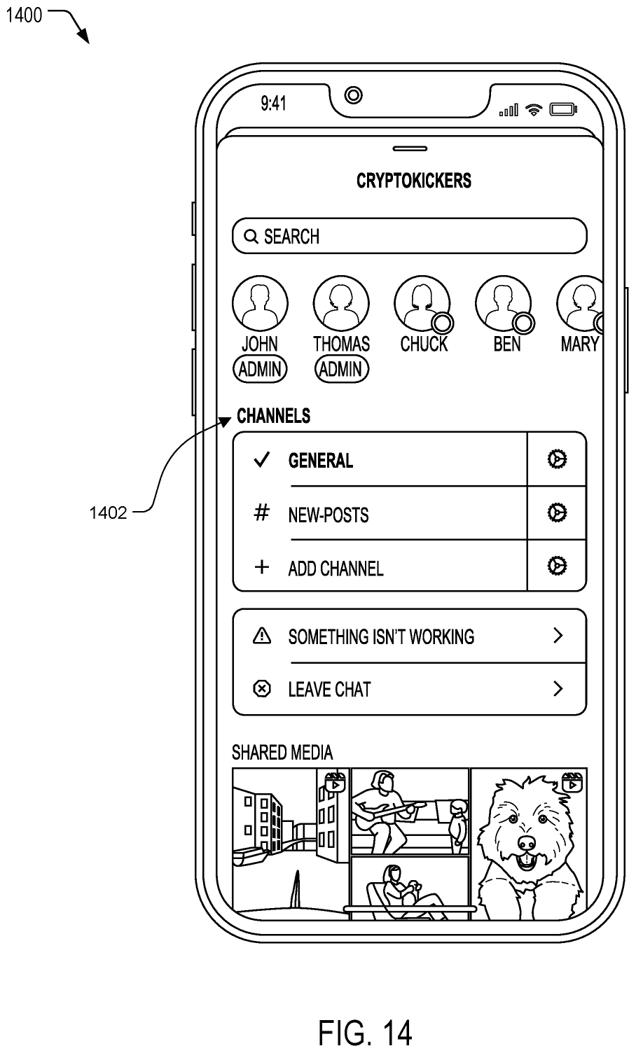

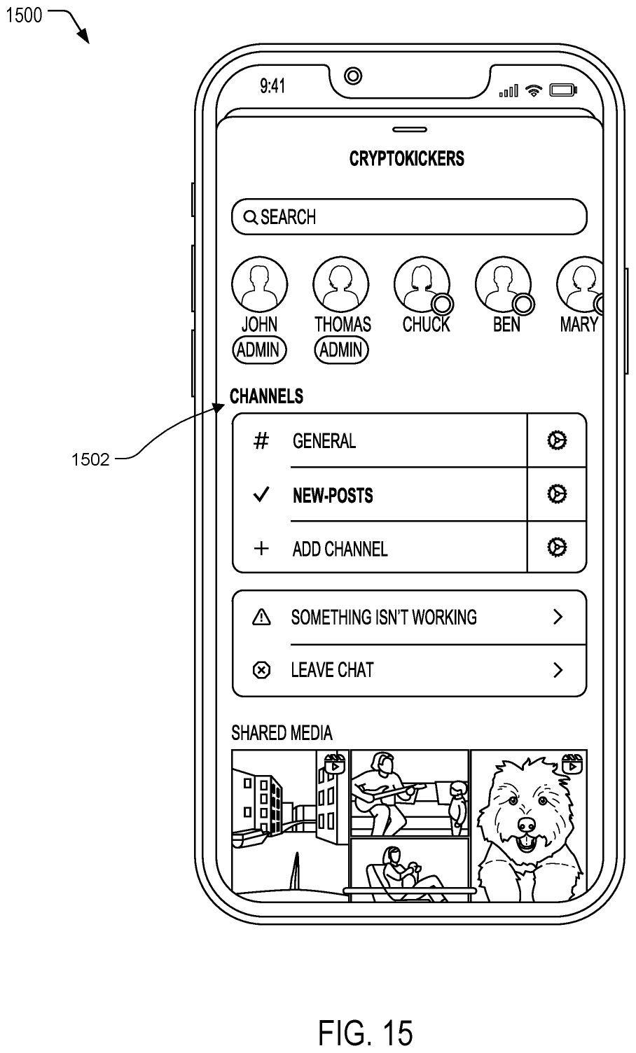

Turning now to FIG. 14, illustrated therein is an example interface 1400 for managing communication channels. In particular, example interface 1400 comprises a plurality of interface objects including channel interface object 1402. In some cases, a user may generate a new communication channel by interacting with channel interface object 1402. In some cases, a user may traverse back and forth between various communication channels by interacting with an associated channel interface object. For example, with brief reference to FIG. 15, illustrated is the example interface 1500, wherein channel interface object 1502 is highlighted as an indication that the communication channel “new-posts” has been selected by a user.

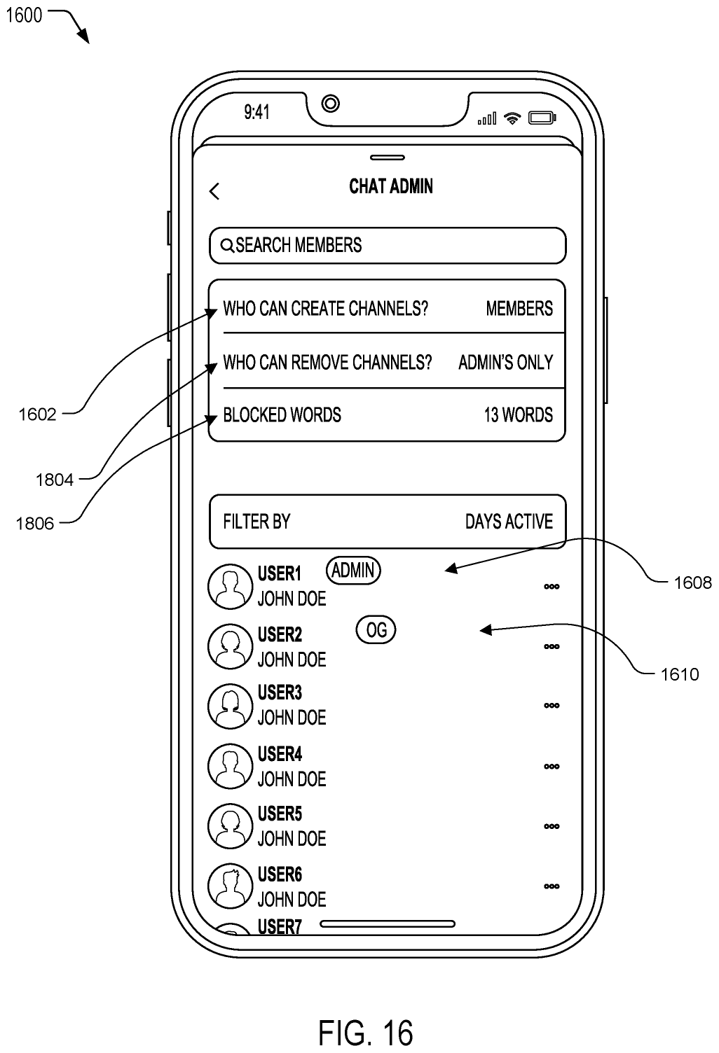

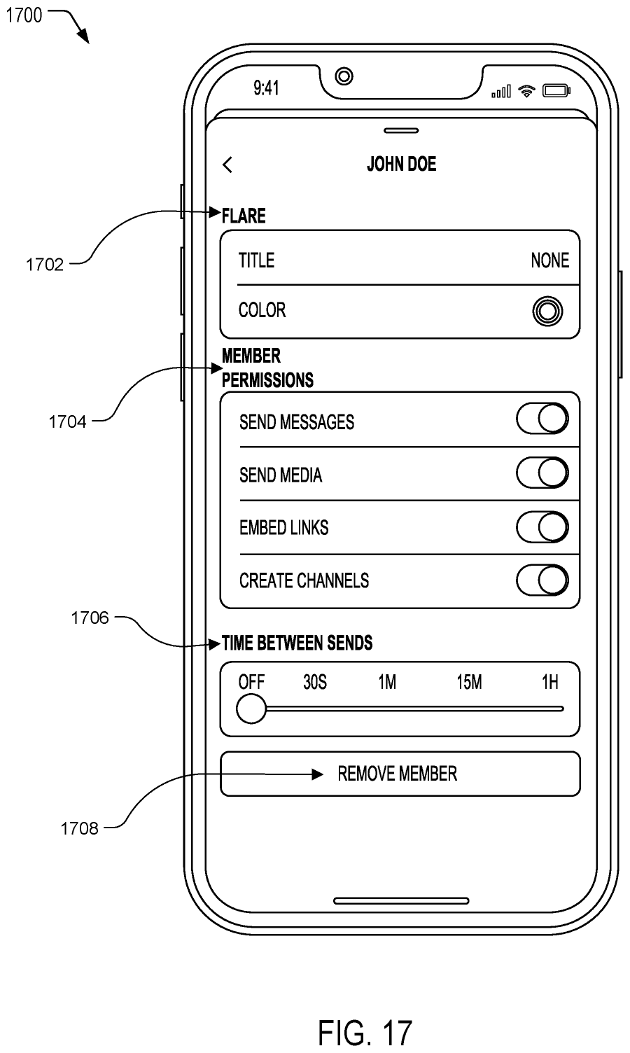

FIGS. 16 and 17 illustrate example interfaces 1600 and 1700, respectively, via which an administrator or originating user may moderate one or more communication channels. For example, as illustrated in the example interface 1600 of FIG. 16, the social networking system 106 may be configured to provide administrative functionality to determine who can create communication channels (e.g., via interface object 1602), who can remove communication channels (e.g., via interface object 1604), and which words are blocked or otherwise restricted from use within the community chat (e.g., via interface object 1606). Also illustrated in the example interface 1600 are distinct visual indicators of user status 1608 and 1610 (herein referred to as “flare”), by which a user may be distinguished as an administrator or original collaborator (i.e., an “OG.)

Turning briefly to FIG. 17, illustrated therein is an example interface 1700 by which an administrator or original collaborator may manage user permissions of an individual co-collaborator. In some cases, the example interface 1700 may comprise a first plurality of flare interface objects 1702, whereby an individual co-collaborator may be imparted a flare to be associated with their username as discussed above with regard to FIG. 17. Example interface 1700 may also comprise member permissions interface objects 1704, by which an administrator may allow or restrict one or more user permissions. Example interface 1700 may also comprise interface object 1706, with which an administrator may restrict for a pre-determined time one or more user permissions (e.g., a right to create/post community content, a right to reply to a community chat, etc.). Via interface object 1708, an administrator may remove an individual co-collaborator from the community profile.

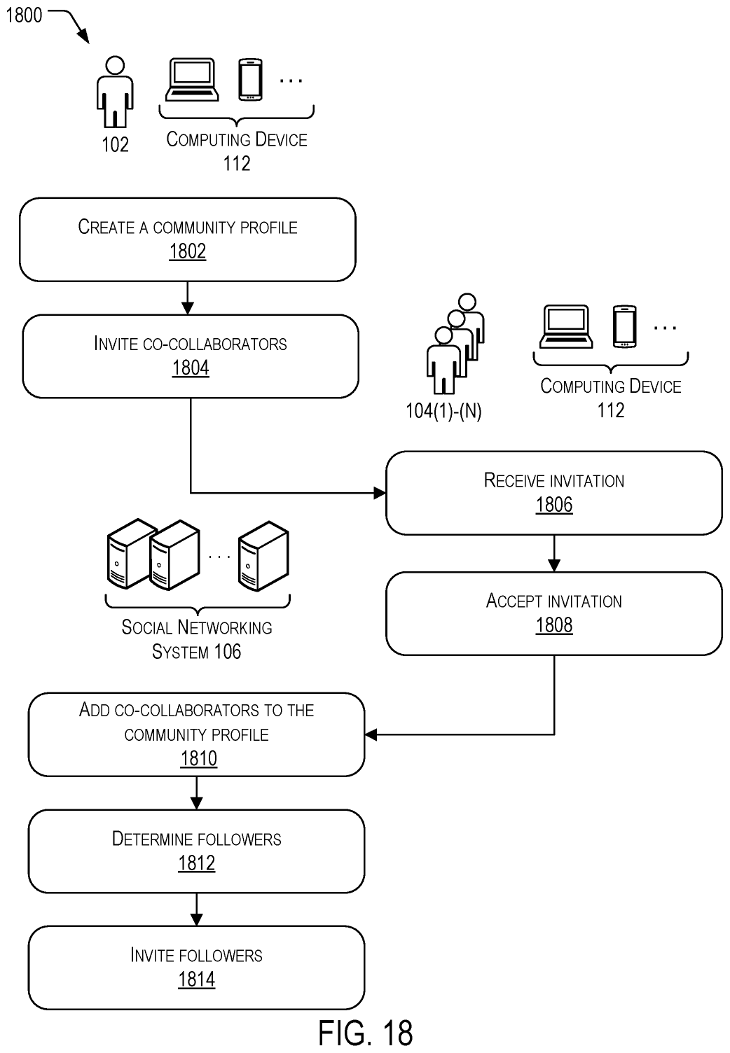

FIGS. 18-20 are flow diagrams illustrating example processes associated with the community profiles as discussed above. The processes are illustrated as a collection of blocks in a logical flow diagram, which represent a sequence of operations, some or all of which can be implemented in hardware, software, or a combination thereof. In the context of software, the blocks represent computer-executable instructions stored on one or more computer-readable media that, which when executed by one or more processors, perform the recited operations. Generally, computer-executable instructions include routines, programs, objects, components, encryption, deciphering, compressing, recording, data structures and the like that perform particular functions or implement particular abstract data types.

The order in which the operations are described should not be construed as a limitation. Any number of the described blocks can be combined in any order and/or in parallel to implement the processes, or alternative processes, and not all of the blocks need be executed. For discussion purposes, the processes herein are described with reference to the frameworks, architectures and environments described in the examples herein, although the processes may be implemented in a wide variety of other frameworks, architectures or environments.

FIG. 18 is a flow diagram illustrating an example process 18 00 for initiating and/or creating a community profile via the social networking system 106, according to some implementations. As discussed above, an original user, such as the user 102 of FIG. 1, may create a community profile and invite other users, such as the users 104 of FIG. 1, to participate as co-collaborators.

At operation 18 02, the user 102 may create a community profile. For example, the user 102 may create an account in a manner of an individual user creating a personal account but select a community profile option allowing multiple users to be account holders, contributors, and otherwise managers of the newly created community profile. For instance, the user 102 may specify identity account content (e.g., account name, address, and the like), background content (e.g., account story, purpose, goals, and the like), demographic or contact content (e.g., personal information of the user 102), initial content (e.g., original posts and the like), and the like.

At operation 18 04, the user 102 may invite or otherwise select other users, such as users 104, to become co-collaborators with respect to the community profile and, at operation 706, the users 104 may receive the invitations. For example, the user 102 may select the users 104 by typing or entering the user's name, selecting the user 104 from a list or other tagged content, and the like. In this implementation, it should be understood that the invitation of the user 104 as co-collaborators may be incorporated into the community profile creation process.

At operation 1808, the users 104 may accept the invitations. For example, the invitation may be in the form of a notification or alert as including a selectable option to accept. If the users 104 accept the invitation, the process 700 proceeds to operation 1810, otherwise the invitation may either remain open, be closed by the user 102, be closed by the user 104, expire after a period of time elapses, and the like. It should be understood that if one or more of the users 104 do not accept the invitation, they will not be added or otherwise associated with the community profile.

At operation 1810, the social networking system 106 may add the co-collaborators to the community profile in response to receiving the corresponding acceptance. Once added, the co-collaborators may be listed in the contributors section 408 of the community profile, as discussed, and/or listed as a contributor to individual items of community content associated with the community profile, as discussed above.

At operation 1812, the social networking system 106 may determine followers of the user 104 that accepted the invitation to invite to follow the community profile and, at operation 1814, the social networking system 106 may send the invite to the followers determined at operation 1812. For example, the social networking system 106 may compare the list of followers of the user 104 with a current list of followers of the community profile and filter the current followers from the followers of the user 104 prior to sending the follower invitations. In this manner, the followers of the user 104 do not receive duplicative invites to follow an account they are already following. In some examples, the social networking system 106 may also filter the followers of the user 104 that accepted the invitation based on followers of other collaborators, such as the user 102 (i.e., the founding or original user). In this manner, the followers of the user 102 that did not accept the invitation to follow the community profile do not receive additional notifications or invitations subsequent to the user 104 accepting the invitation.

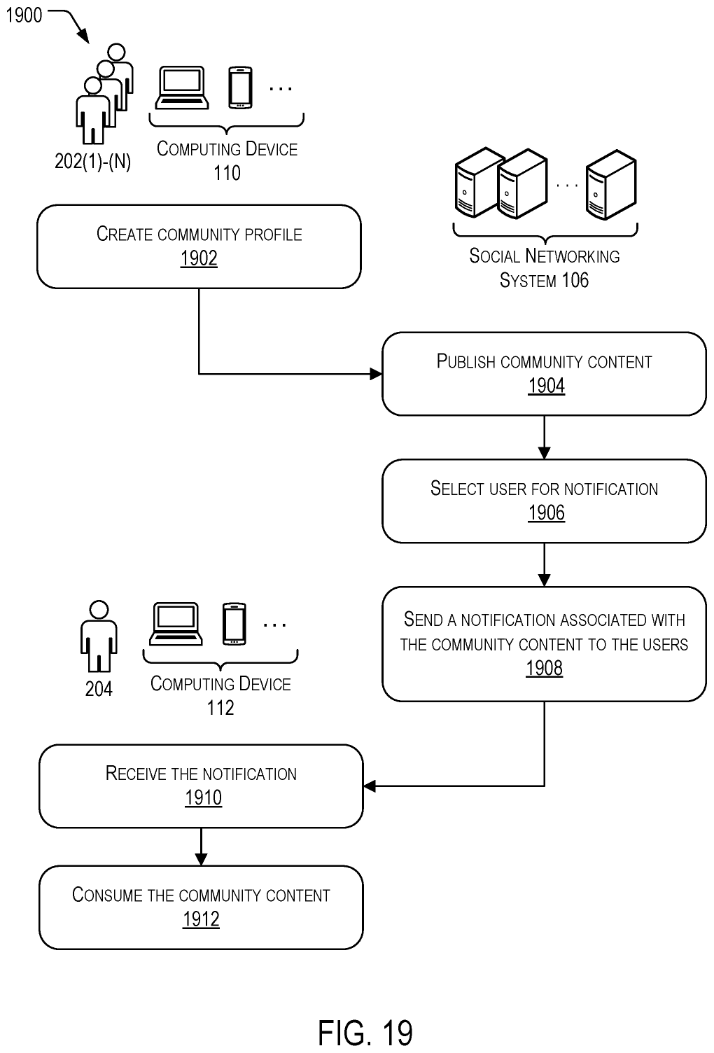

FIG. 19 is a flow diagram illustrating an example process 1900 for creating community content for a community profile via the social networking system 106 according to some implementations. In some cases, collaborators of a community profile may create, add, edit, remove and otherwise modify community content associated with the community profile, such as the users 202 of FIG. 2. Likewise, users of the social networking system 106, such as users 204 of FIG. 2, may consume the community content associated with the community profile.

At operation 1902, any one or more of the users 202 may create community content for the community profile. The community content may be associated with, posted to, and/or hosted by the community profile. In some cases, the community content may be generated in a manner of an individual user creating personal content, but allow for multiple editors (e.g., the users 202) and/or attribution to multiple users (e.g., a subset of the users 202). In various examples, contributors, as discussed above, may be assigned to the community content and their personal account information may be displayed in conjunction with the community content.

At operation 1904, the social networking system 106 may publish the community content to the community profile. For instance, the content may be stored at a location associated with the community profile and displayed on a home page or other feed associated with the community profile.

At operation 1906, the social networking system 106 may select users, such as the users 204, to receive a notification associated with the community content and, at operation 1908, the social networking system 106 may send a notification associated with the community content to the selected users. The notification may include access to the community content, details associated with the community content, details associated with the community profile and/or the contributing collaborators, and the like. In some examples, the users 204 selected to receive the notification may be determined based on a status of the users 204, such as followers of the community profile, followers of a contributor to the community content, and/or followers of other co-collaborators of the community profile. In some examples, the users 204 may include a union of the followers of the users 202 and followers of the community profile, such that no users receive the notification related to the newly created content more than once.

At operation 1910, the users 204 may receive the notification and, at operation 1912, the users 204 may consume (e.g., access and/or interact with and the like) the community content. In some cases, the notification may be a summary or highlight of the community content, such as one or more selected images or short videos (e.g., GIFs) associated with the collaborative content, a short text-based description, or other insight into the subject or topic of the collaborative content. In some cases, the content of the notification may be selected by the users 202 when creating the community content, such as a selected featured image or portion of a video. In some cases, the notification may include a link to access or otherwise consume the content via the social networking system 106.

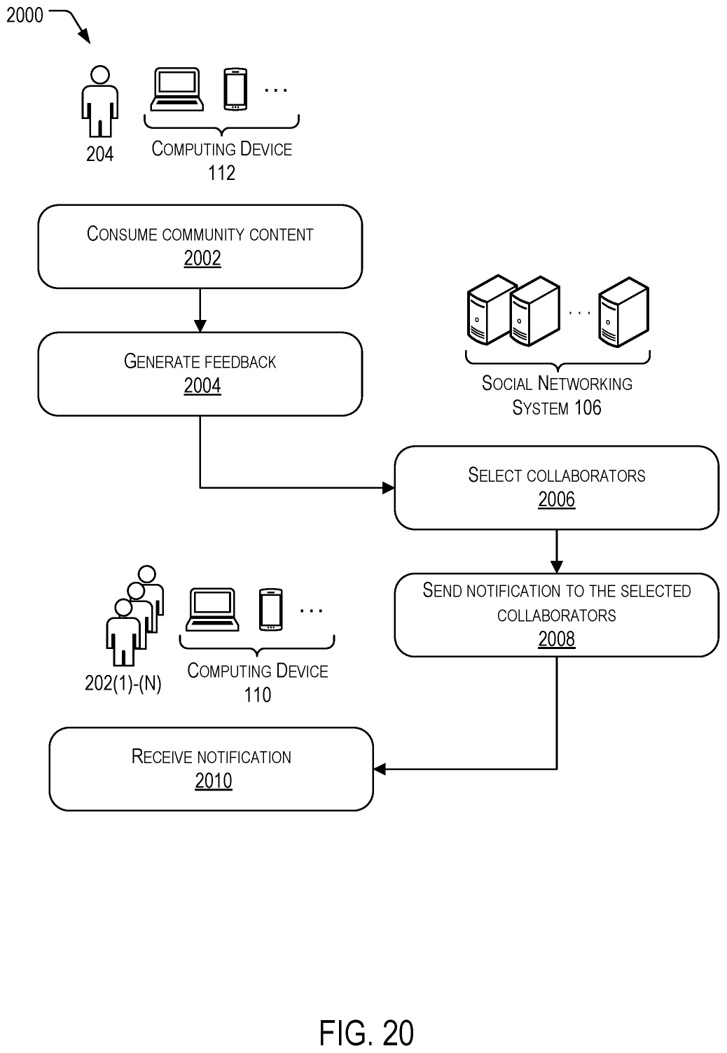

FIG. 20 is a flow diagram illustrating an example process 2000 associated with feedback to community content associated with a community profile, according to some implementations. As discussed above, users, such as users 204 of FIGS. 2 and 3, may be notified regarding and consume community content posted to/by a community profile.

At operation 2002, one or more of the users 204 may consume the community content. For example, one or more of the users 204 may consume the community content by viewing the community content via the notification discussed above and/or by viewing the community profile's home page.

At operation 2004, one or more of the users 204 may generate feedback associated with the community content posted to the community profile. For example, the feedback may include comments, likes, dislikes, shares, reposts as well as other feedback related to the community content posted to the community profile.

At operation 2006, the social networking system 106 may select collaborators associated with the community profile to receive the feedback and/or a notification associated with the feedback. For example, the social networking system 106 may select the collaborators based at least in part on content of the feedback, the type of feedback, the users that contributed to the community content, and the like.

At operation 2008, the social networking system 106 may send a notification to the selected collaborators and, at operation 2010, the collaborators may receive the notification. The collaborators may then respond in various manners as described herein to the feedback.

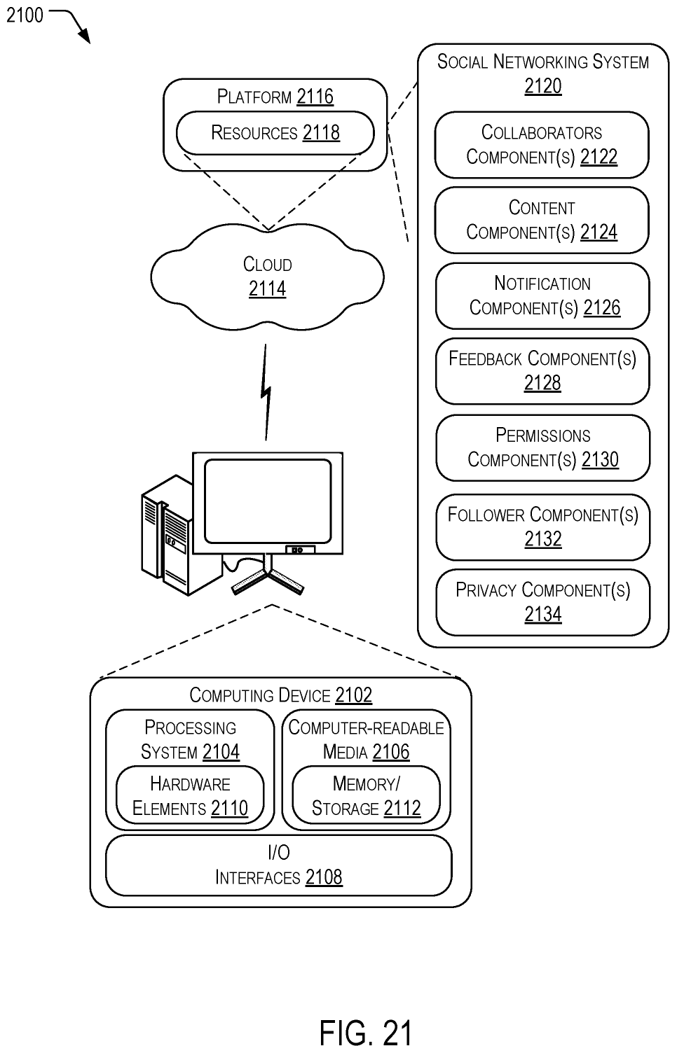

FIG. 21 illustrates an example system 1000 that includes an example computing device 2102 that is representative of one or more computing systems and/or devices that may implement the various techniques described herein. This is illustrated through inclusion of a social networking system 1020, which may be similar to social networking system 106 of FIG. 1. The illustrated social networking system 2120 comprises a collaborators component 2122, a content component 2124, a notification component 2126, a feedback component 2128, a permissions component 2130, a follower component 2132, and a privacy component 2134.

The collaborators component 2122 may be configured to assist a founding user with respect to adding or inviting other users to become co-collaborators with respect to the community profile.

The content component 2124 may be configured to assist with creating or generating community content and attributing credit between the collaborators with respect to the newly created community content.

The notification component 2126 may be configured to provide notification(s) related to newly added community content and/or feedback to, respectively, the users of the social networking system 2120 and the collaborators of the community profile.

The feedback component 2128 may be configured to assist with identifying one or more users to receive the feedback related to the community content. For example, the feedback component 2128 may select one or more of the collaborators to receive and respond to the feedback on any particular community content item to, for instance, avoid duplicative responses and follow up with respect to the feedback.

The permissions component 2130 may be configured to allow a founding or original user, such as the user 102 of FIG. 1, or other designated collaborator to control permissions with respect to the community profile and the other co-collaborators. For example, the permissions component 2130, alone or in conjunction with other components or circuitry described herein, may be configured to provide functionality to one or more collaborators to administer the community profile. For example, the permissions component 2130 may be configured to provide one or more collaborators with functionality to edit one or more community profile settings (e.g., block users, remove and/or restrict users, etc.).

The follower component 2132 may be configured to assist with selecting followers of collaborators to invite to follow the community profile. The follower component 2132 may also be configured to select individual users to receive notifications of community content posted with respect to the community profile.

The privacy component 2134 may be configured to allow the community profile to act as a public community profile or a private community profile. As a public community profile, the community profile may act as a “stand-alone” account viewable by any users of the social networking system 2120 in the manner of accounts held by a single user, while allowing and attributing community content to multiple holders, editors, contributors, and the like. However, when the community profile engages a private setting, the community content of the community profile may be accessible only by the contributors and, thereby, provide a closed space with respect to the social networking system 2120 for the collaborators to develop content, share data, otherwise communicate with each other, and the like. In this manner, the privacy component 2134 may be configured to provide a founding or original user (i.e., the user 102 of FIG. 1) and/or one or more administrators of the community profile functionality to approve or reject requests to be associated with the community profile.

The computing device 2102 may be, for example, a server of a service provider, a device associated with a client (e.g., a client device), an on-chip system, and/or any other suitable computing device or computing system. The example computing device 2102 as illustrated includes a processing system 2104, one or more computer-readable media 2106, and one or more I/O interfaces 2108 that are communicatively coupled, one to another. Although not shown, the computing device 2102 may further include a system bus or other data and command transfer system that couples the various components, one to another. A system bus can include any one or combination of different bus structures, such as a memory bus or memory controller, a peripheral bus, a universal serial bus, and/or a processor or local bus that utilizes any of a variety of bus architectures. A variety of other examples are also contemplated, such as control and data lines.

The processing system 2104 is representative of functionality to perform one or more operations using hardware. Accordingly, the processing system 2104 is illustrated as including hardware elements 2110 that may be configured as processors, functional blocks, and so forth. This may include implementation in hardware as an application specific integrated circuit or other logic device formed using one or more semiconductors. The hardware elements 2110 are not limited by the materials from which they are formed, or the processing mechanisms employed therein. For example, processors may be comprised of semiconductor(s) and/or transistors (e.g., electronic integrated circuits (ICs)). In such a context, processor-executable instructions may be electronically-executable instructions.

The computer-readable storage media 2106 is illustrated as including memory/storage 2112. The memory/storage 2112 represents memory/storage capacity associated with one or more computer-readable media. The memory/storage 2112 may include volatile media (such as random access memory (RAM)) and/or nonvolatile media (such as read only memory (ROM), Flash memory, optical disks, magnetic disks, and so forth). The memory/storage 2112 may include fixed media (e.g., RAM, ROM, a fixed hard drive, and so on) as well as removable media (e.g., Flash memory, a removable hard drive, an optical disc, and so forth). The computer-readable media 2106 may be configured in a variety of other ways as further described below.

Input/output interface(s) 2108 are representative of functionality to allow a user to enter commands and information to computing device 2102, and also allow information to be presented to the user and/or other components or devices using various input/output devices. Examples of input devices include a keyboard, a cursor control device (e.g., a mouse), a microphone, a scanner, touch functionality (e.g., capacitive or other sensors that are configured to detect physical touch), a camera (e.g., which may employ visible or non-visible wavelengths such as infrared frequencies to recognize movement as gestures that do not involve touch), and so forth. Examples of output devices include a display device (e.g., a monitor or projector), speakers, a printer, a network card, tactile-response device, and so forth. Thus, the computing device 2102 may be configured in a variety of ways as further described below to support user interaction.

Various techniques may be described herein in the general context of software, hardware elements, or program modules. Generally, such modules include routines, programs, objects, elements, components, data structures, and so forth that perform particular tasks or implement particular abstract data types. The terms “module,” “functionality,” “logic,” and “component” as used herein generally represent software, firmware, hardware, or a combination thereof. The features of the techniques described herein are platform-independent, meaning that the techniques may be implemented on a variety of commercial computing platforms having a variety of processors.

An implementation of the described modules and techniques may be stored on and/or transmitted across some form of computer-readable media. The computer-readable media may include a variety of media that may be accessed by the computing device 2102. By way of example, and not limitation, computer-readable media may include “computer-readable storage media” and “computer-readable transmission media.”

“Computer-readable storage media” may refer to media and/or devices that enable persistent and/or non-transitory storage of information in contrast to mere signal transmission, carrier waves, or signals per se. Thus, computer-readable storage media refers to non-signal bearing media. The computer-readable storage media includes hardware such as volatile and non-volatile, removable and non-removable media and/or storage devices implemented in a method or technology suitable for storage of information such as computer-readable instructions, data structures, program modules, logic elements/circuits, or other data. Examples of computer-readable storage media may include, but are not limited to, RAM, ROM, EEPROM, flash memory or other memory technology, CD-ROM, digital versatile disks (DVD) or other optical storage, hard disks, magnetic cassettes, magnetic tape, magnetic disk storage or other magnetic storage devices, or other storage device, tangible media, or article of manufacture suitable to store the desired information and which may be accessed by a computer.

“Computer-readable transmission media” may refer to a medium that is configured to transmit instructions to the hardware of the computing device 2102, such as via a network. Computer-readable transmission media typically may transmit computer-readable instructions, data structures, program modules, or other data in a modulated data signal, such as carrier waves, data signals, or other transport mechanism. Computer-readable transmission media also includes any information delivery media. The term “modulated data signal” means a signal that has one or more of its characteristics set or changed in such a manner as to encode information in the signal. By way of example, and not limitation, computer-readable transmission media include wired media such as a wired network or direct-wired connection, and wireless media such as acoustic, radio frequency (RF), infrared, and other wireless media.

As previously described, hardware elements 2110 and computer-readable media 2106 are representative of modules, programmable device logic and/or device logic implemented in a hardware form that may be employed in some embodiments to implement at least some aspects of the techniques described herein, such as to perform one or more instructions. Hardware may include components of an integrated circuit or on-chip system, an application-specific integrated circuit (ASIC), a field-programmable gate array (FPGA), a complex programmable logic device (CPLD), and other implementations in silicon or other hardware. In this context, hardware may operate as a processing device that performs program tasks defined by instructions and/or logic embodied by the hardware as well as a hardware utilized to store instructions for execution, e.g., the computer-readable storage media described previously.

Combinations of the foregoing may also be employed to implement various techniques described herein. Accordingly, software, hardware, or executable modules may be implemented as one or more instructions and/or logic embodied on some form of computer-readable storage media and/or by one or more hardware elements 2110. The computing device 2102 may be configured to implement particular instructions and/or functions corresponding to the software and/or hardware modules. Accordingly, implementation of a module that is executable by the computing device 2102 as software may be achieved at least partially in hardware, e.g., through use of computer-readable storage media and/or hardware elements 2110 of the processing system 2104. The instructions and/or functions may be executable/operable by one or more articles of manufacture (for example, one or more computing devices 2102 and/or processing systems 2104) to implement techniques, modules, and examples described herein.

The techniques described herein may be supported by various configurations of the computing device 2102 and are not limited to the specific examples of the techniques described herein. This functionality may also be implemented all or in part through use of a distributed system, such as over a computing environment or “cloud” 2114 via a platform 2116 as described below.

The cloud 2114 includes and/or is representative of a platform 2116 for resources 2118. The platform 2116 abstracts underlying functionality of hardware (e.g., servers) and software resources of the cloud 2114. The resources 2118 may include applications and/or data that can be utilized while computer processing is executed on servers that are remote from the computing device 2102. Resources 2118 can also include services provided over the Internet and/or through a subscriber network, such as a cellular or Wi-Fi network.

The platform 2116 may abstract resources and functions to connect the computing device 2102 with other computing devices. The platform 2116 may also be scalable to provide a corresponding level of scale to encountered demand for the resources 2118 that are implemented via the platform 2116. Accordingly, in an interconnected device embodiment, implementation of functionality described herein may be distributed throughout multiple devices of the system 2100. For example, the functionality may be implemented in part on the computing device 2102 as well as via the platform 2116 which may represent a cloud computing environment 2114.

### CONCLUSION

Although the discussion above sets forth example implementations of the described techniques, other architectures may be used to implement the described functionality and are intended to be within the scope of this disclosure. Furthermore, although the subject matter has been described in language specific to structural features and/or methodological acts, it is to be understood that the subject matter defined in the appended claims is not necessarily limited to the specific features or acts described. Rather, the specific features and acts are disclosed as exemplary forms of implementing the claims.

What is claimed is:

1. A method comprising:
receiving, from a first collaborator of a community profile of a social networking system, a first request to create a communication channel with the social networking system, the first request indicating a second collaborator of the account of the social networking system to associate with the communication channel;
sending, to the second collaborator, an invitation to be associated with the communication channel, the invitation comprising one of an administrative designation or a non-administrative designation with regard to the association of the second collaborator with the communication channel;
receiving, from the second collaborator, an acceptance of the invitation; and
adding, in response to receiving the acceptance, the second collaborator as a participant in the communication channel.

2. The method as recited in claim 1, wherein adding the second collaborator as a participant in the communication further comprises granting a permission to the second collaborator with respect to the communication channel, the permission comprising at least one of:
a first permission to post content within the communication channel;
a second permission to edit content within the communication channel; or
a third permission to generate feedback to content within the communication channel.

3. The method as recited in claim 2, wherein the invitation comprises the administrative designation, and further comprising granting a fourth permission to edit one or more communication channel settings.

4. The method as recited in claim 3, wherein granting the fourth permission further comprises causing an identifier associated with the second collaborator to be presented via an interface associated with the communication channel.

5. The method as recited in claim 3, wherein the one or more communication channel settings comprise:
a setting associated with creation of a communication channel;
a setting associated with removal of a communication channel;
a setting associated with restricted words within a communication channel; and
one or more user-level permissions.

6. The method as recited in claim 1, further comprising:
receiving, from the first collaborator, a second request to disassociate the second collaborator and the communication channel; and
removing, in response to receiving the second request, the second collaborator as a participant in the communication channel.

7. The method as recited in claim 1, further comprising:
receiving, from one or more of the first collaborator and the second collaborator, a request to partition the communication channel into a first communication channel and a second communication channel.

8. The method as recited in claim 7, wherein the second communication channel comprises a plurality of communications associated with a first communication topic of the first communication channel.

9. One or more non-transitory computer-readable media storing instructions that, when executed by one or more processors, cause one or more computing devices to perform operations comprising:
receiving, from a first collaborator of a community profile of a social networking system, a first request to create a communication channel with the social networking system, the first request indicating a second collaborator of the account of the social networking system to associate with the communication channel;
sending, to the second collaborator, an invitation to be associated with the communication channel, the invitation comprising one of an administrative designation or a non-administrative designation with regard to the association of the second collaborator with the communication channel;
receiving, from the second collaborator, an acceptance of the invitation; and
adding, in response to receiving the acceptance, the second collaborator as a participant in the communication channel.

10. The one or more non-transitory computer-readable media as recited in claim 9, wherein adding the second collaborator as a participant in the communication further comprises granting a permission to the second collaborator with respect to the communication channel, the permission comprising at least one of:
a first permission to post content within the communication channel;
a second permission to edit content within the communication channel; or
a third permission to generate feedback to content within the communication channel.

11. The one or more non-transitory computer-readable media as recited in claim 9, wherein the invitation comprises the administrative designation, and further comprising granting a fourth permission to edit one or more communication channel settings.

12. The one or more non-transitory computer-readable media as recited in claim 11, wherein granting the fourth permission further comprises causing an identifier associated with the second collaborator to be presented via an interface associated with the communication channel.

13. The one or more non-transitory computer-readable media as recited in claim 11, wherein the one or more communication channel settings comprise:
a setting associated with creation of a communication channel;
a setting associated with removal of a communication channel;
a setting associated with restricted words within a communication channel; and
one or more user-level permissions.

14. The one or more non-transitory computer-readable media as recited in claim 9, wherein the operations further comprise:
receiving, from the first collaborator, a second request to disassociate the second collaborator and the communication channel; and
removing, in response to receiving the second request, the second collaborator as a participant in the communication channel.

15. A system comprising:
one or more processors; and
one or more computer-readable media storing instructions that, when executed by the one or more processors, cause the system to perform operations comprising:
receiving, from a first collaborator of a community profile of a social networking system, a first request to create a communication channel with the social networking system, the first request indicating a second collaborator of the account of the social networking system to associate with the communication channel;
sending, to the second collaborator, an invitation to be associated with the communication channel, the invitation comprising one of an administrative designation or a non-administrative designation with regard to the association of the second collaborator with the communication channel;
receiving, from the second collaborator, an acceptance of the invitation; and
adding, in response to receiving the acceptance, the second collaborator as a participant in the communication channel.

16. The system as recited in claim 15, wherein the operations further comprise:
receiving, from the first collaborator, a second request to disassociate the second collaborator and the communication channel; and
removing, in response to receiving the second request, the second collaborator as a participant in the communication channel.

17. The system as recited in claim 15, wherein the invitation comprises the administrative designation, and further comprising granting a fourth permission to edit one or more communication channel settings.

18. The system as recited in claim 17, wherein granting the fourth permission further comprises causing an identifier associated with the second collaborator to be presented via an interface associated with the communication channel.

19. The system as recited in claim 17, wherein the one or more communication channel settings comprise:
a setting associated with creation of a communication channel;
a setting associated with removal of a communication channel;
a setting associated with restricted words within a communication channel; and
one or more user-level permissions.

20. The system as recited in claim 15, wherein the operations further comprise:
receiving, from one or more of the first collaborator and the second collaborator, a request to partition the communication channel into a first communication channel and a second communication channel.
